(19) United States
(12) Patent Application Publication
(10) Pub. No.: US 2018/0121432 A1
(43) Pub. Date: May 3, 2018

(54) DIGITAL ASSISTANT INTEGRATION WITH MUSIC SERVICES

(71) Applicant: Microsoft Technology Licensing, LLC, Redmond, WA (US)

(72) Inventors: Jeanne Allison Parson, Hayward, CA (US); August Kathryn Niehaus, Issaquah, WA (US); Robin Lyn Goldstein, Rueil-Malmaison (FR); Melissa Lim, Paris (FR)

(21) Appl. No.: 15/341,703

(22) Filed: Nov. 2, 2016

(51) Int. Cl. G06F 17/30; G06F 9/44

(52) U.S. Cl. CPC G06F 17/30053; G06F 17/30772; G06F 9/4446

(57) ABSTRACT

A digital assistant supported across devices such as smartphones, tablets, personal computers (PCs), wearable computing devices, game consoles, and the like is configured to interact with one or more music and/or search services so that various user experiences, content, or features that enhance a user's involvement with music and other media content can be integrated with the digital assistant and rendered as a native digital assistant user experience. The digital assistant is configured to behave like the user's personal radio host or disc jockey (DJ), for example, by determining the user's intent and preferences, maintaining awareness of history and context, performing tasks and actions to curate personalized playlists and offer them at contextually-relevant times and places, providing information, recommendations, content, and commentary relating to the user's music, and proactively interacting with the user to make existing music easy to find and new music easy to discover.

### BACKGROUND

Digital assistants can provide a variety of features for device users and can make it easier to interact with devices to perform tasks, get information, and stay connected with friends and colleagues using voice interactions and other inputs. Digital assistants are sometimes referred to as “virtual assistants.”

### SUMMARY

A digital assistant supported across devices such as smartphones, tablets, personal computers (PCs), wearable computing devices, game consoles, and the like is configured to interact with one or more music and/or search services so that various user experiences, content, or features that enhance a user's involvement with music and other media content can be integrated with the digital assistant and rendered as a native digital assistant user experience. The digital assistant is configured to behave like the user's personal radio host or disc jockey (DJ), for example, by determining the user's intent and preferences, maintaining awareness of history and context, performing tasks and actions to curate personalized playlists and offer them at contextually-relevant times and places, providing information, recommendations, content, and commentary relating to the user's music, and proactively interacting with the user to make existing music easy to find and new music easy to discover.

Integration of the digital assistant with the music and search services enables provision of a broad suite of personalized music features to the user through a single and consistent user interface (UI) to the digital assistant using graphics, audio (e.g., voice), and/or haptics. Natural language, physical, and/or gesture-based UIs can be exposed across each of the user's computing devices so that the digital assistant can proactively reach out to the user and interact to make music more enjoyable while reducing the user's work and effort. Instead of operating in a conventional reactive manner to a user (i.e., using simple command and control), the digital assistant can readily engage as an active participant in the user's listening experience so that music is more personalized, engaging, and immersive.

In various illustrative examples, the user can invoke a DJ mode for her music experiences in which the digital assistant maintains context awareness using device sensors and other device or user data to identify opportunities to play user-defined playlists or playlists that are specifically curated for the user by the digital assistant. For example, the digital assistant can predict when the user is likely to be in a music-listening context and then personally curate the music to that context. The digital assistant can leverage the wide scope of information available to the search service to provide commentary and related information about a song or artist in a playlist as would a human radio host or DJ. But the digital assistant can also make the music experience more comprehensive and enjoyable to the user by taking actions such as finding live concert performances for artists and purchasing tickets for the user and her friends. The digital assistant's context-awareness enables it to automatically launch DJ mode at relevant times and places. For example, when the user gets into her car for a trip to the beach, the digital assistant can start DJ mode and play a personalized curated playlist of content that matches the user's expectations for a fun day in the sun.

With notice to the user and consent, the digital assistant can observe the user's interactions and behaviors with the digital assistant and other applications and look at data from the user's calendar/scheduling applications, contact lists, social media applications, and the like to track context that is applicable to the user. The digital assistant's maintenance of such context awareness makes it easy for the user to find songs and artists. For example, rather than needing to remember a title, playlist, or other identifying characteristics of a song, the user can ask the digital assistant “play the songs that Jennifer played for me on the bus trip last week.” The digital assistant can replay the requested songs and suggest other artists, songs, and playlists that the user may also like. If the user does not have the particular songs or playlist stored on her devices or cloud-storage, the digital assistant can take, for example, proactive steps to launch a streaming music or app store service that can provide the desired content. If the user has a recollection of just a few lyrics in a desired song, or can only remember the song's theme or mood, the digital assistant's access to the search service can facilitate fast and accurate identification of the sought-after content.

The ability to identify relevant context also enables the digital assistant to curate highly personalized playlists that can be proactively surfaced at times when the digital assistant predicts that the user is likely to want to listen to music. The digital assistant can consider the user's habits, current location, mood and/or energy level, and music playback history to suggest or play personalized playlists that are curated for the user by the digital assistant. For example, if the digital assistant determines that the user works out at particular times on particular days, it can customize a playlist for the user that may be suggested or played when the user arrives at a fitness center. If the user listens to some suggested playlists but rejects other suggestions, the digital assistant can employ that feedback from the user to refine the playlist personalization methodologies. In some implementations, the digital assistant can employ crowd-sourced data from a population of users to make the customization personalization more accurate and robust by identifying trends, preferences, and behaviors. Crowd-sourced data can also be used to create curated playlists for groups of people attending events such as parties and celebrations. In other implementations, the digital assistant can interact with the user by surfacing notifications and other UI constructs such as user preference dialogs, tooltips, and hints to aid in the personalization and collection of feedback.

The integration of the digital assistant with music and search services can increase the efficiency of the human-machine interface between the user and the devices by enabling suitable content to be identified from diverse sources and curated in a natural, accurate, and robust manner using a consistent UI. The automated and proactive steps taken by the digital assistant to curate personalized and context-relevant playlists can further enhance device operation efficiency by reducing the opportunities for user input errors. For example, the digital assistant's automated identification and playback of desired content is more efficient than manual operations performed by a user which may be time consuming and prone to error. Such increased efficiency may enable the device to better utilize available computing resources including network bandwidth, processing cycles, memory, and battery life which may often be limited in some cases.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative computing environment in which devices supporting a digital assistant can communicate and interact with various services over a network;

FIGS. 2, 3, and 4 show screen captures of illustrative graphical user interfaces (GUIs) that are exposed on a device by a digital assistant;

FIGS. 5-11 show transcripts of illustrative user experiences with a digital assistant;

FIG. 12 shows an illustrative GUI rendered on a computing device that shows interactions between a device user and a digital assistant;

FIG. 13 shows an illustrative field of view provided by a head mounted display (HMD) device;

FIG. 14 shows an illustrative example of a digital assistant operating in a car;

FIG. 15 shows an illustrative example of a digital assistant operating in DJ mode on a device at an event;

FIG. 16 shows in illustrative local DJ client interacting with a remote DJ service;

FIG. 17 shows illustrative functions that may be performed by a DJ system;

FIG. 18 shows illustrative inputs to a digital assistant and an illustrative taxonomy of general functions that may be performed by a digital assistant;

FIGS. 19, 20, and 21 show illustrative interfaces between a user and a digital assistant;

FIG. 22 shows an illustrative layered architecture;

FIGS. 23, 24, and 25 show illustrative methods that may be performed when implementing the present digital assistant integration with music services;

FIG. 26 is a simplified block diagram of an illustrative computer system such as a personal computer (PC) that may be used in part to implement the present digital assistant integration with music services;

FIG. 27 shows a block diagram of an illustrative device that may be used in part to implement the present digital assistant integration with music services;

FIG. 28 is a pictorial view of an illustrative example of a virtual reality or mixed reality HMD device;

FIG. 29 shows a block diagram of an illustrative example of an augmented reality HMD device;

FIG. 30 is a block diagram of an illustrative device such as a mobile phone or smartphone; and

FIG. 31 is a block diagram of an illustrative multimedia console.

Like reference numerals indicate like elements in the drawings. Elements are not drawn to scale unless otherwise indicated.

### DETAILED DESCRIPTION

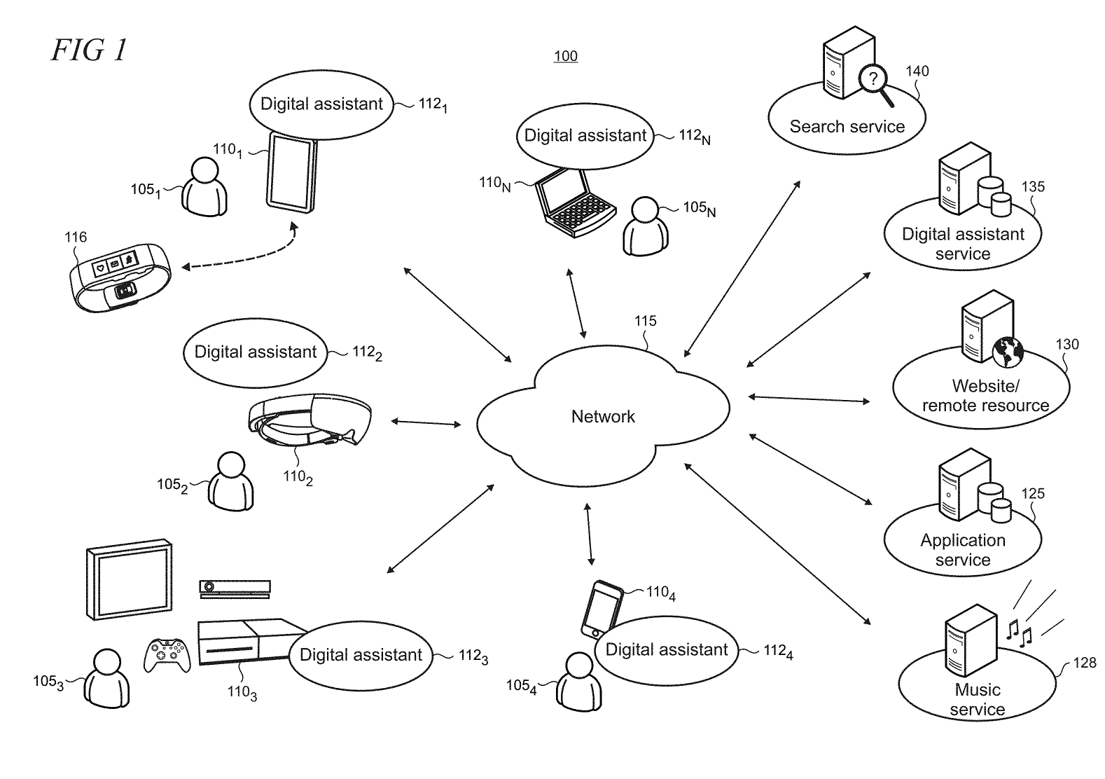

FIG. 1 shows an illustrative computing environment 100 in which the same or different users 105 may employ devices 110 that can communicate with other devices and various services over a network 115. Each device 110 may include an instance of a digital assistant 112. The devices 110 can support voice telephony capabilities in some cases and typically support data-consuming applications such as Internet browsing and multimedia (e.g., music, video, etc.) consumption in addition to various other features. The devices 110 may include, for example, user equipment, mobile phones, cell phones, feature phones, tablet computers, and smartphones which users often employ to make and receive voice and/or multimedia (i.e., video) calls, engage in messaging (e.g., texting) and email communications, use applications and access services that employ data, browse the World Wide Web, and the like.

Other types of electronic devices are also envisioned to be usable within the environment 100 including handheld computing devices, PDAs (personal digital assistants), portable media players, devices that use headsets and earphones (e.g., Bluetooth-compatible devices), phablet devices (i.e., combination smartphone/tablet devices), wearable computing devices such as head-mounted display (HMD) systems and smartwatches, navigation devices such as GPS (Global Positioning System) systems, laptop PCs (personal computers), desktop computers, multimedia consoles, gaming systems, intelligent or smart speaker devices, or the like. In the discussion that follows, the use of the term “device” is intended to cover all devices that are configured with communication capabilities and are capable of connectivity to the network 115.

The various devices 110 in the environment 100 can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, and voice commands, while others may enable a more limited user interface. Some devices may support video consumption and Internet browsing, while other devices may support more limited media handling and network interface features.

Accessory devices 116, such as wristbands and other wearable computing devices may also be present in the environment 100. Such accessory device 116 typically is adapted to interoperate with a coupled device 110 using a short range communication protocol like Bluetooth to support functions such as monitoring of the wearer's fitness and/or physiology (e.g., heart rate, steps taken, calories burned, etc.) and environmental conditions (temperature, humidity, ultra-violet (UV) levels, etc.), and surfacing notifications from the coupled device 110. Some accessory devices can be configured to work on a standalone basis (i.e., without relying on a coupled device 110 for functionality such as Internet connectivity) as wearable computing devices that may support an operating system and applications.

The devices 110 can typically utilize the network 115 in order to access and/or implement various user experiences. The network can include any of a variety of network types and network infrastructure in various combinations or sub-combinations including cellular networks, satellite networks, IP (Internet-Protocol) networks such as Wi-Fi under IEEE 802.11 and Ethernet networks under IEEE 802.3, a public switched telephone network (PSTN), and/or short range networks such as Bluetooth® networks. The network infrastructure can be supported, for example, by mobile operators, enterprises, Internet service providers (ISPs), telephone service providers, data service providers, and the like.

The network 115 may utilize portions of the Internet or include interfaces that support a connection to the Internet so that the devices 110 can access content and render user experiences provided by various remote or cloud-based application services 125 and websites 130 or other remote resources. The application services 125 and websites 130 can support a diversity of features, services, and user experiences such as social networking, mapping, news and information, entertainment, travel, productivity, finance, etc. A music service 128, digital assistant service 135, and search service 140 (each described in more detail below) are also present in the computing environment 100. The music and search services can be first party services or third party services depending on the circumstances surrounding a given implementation.

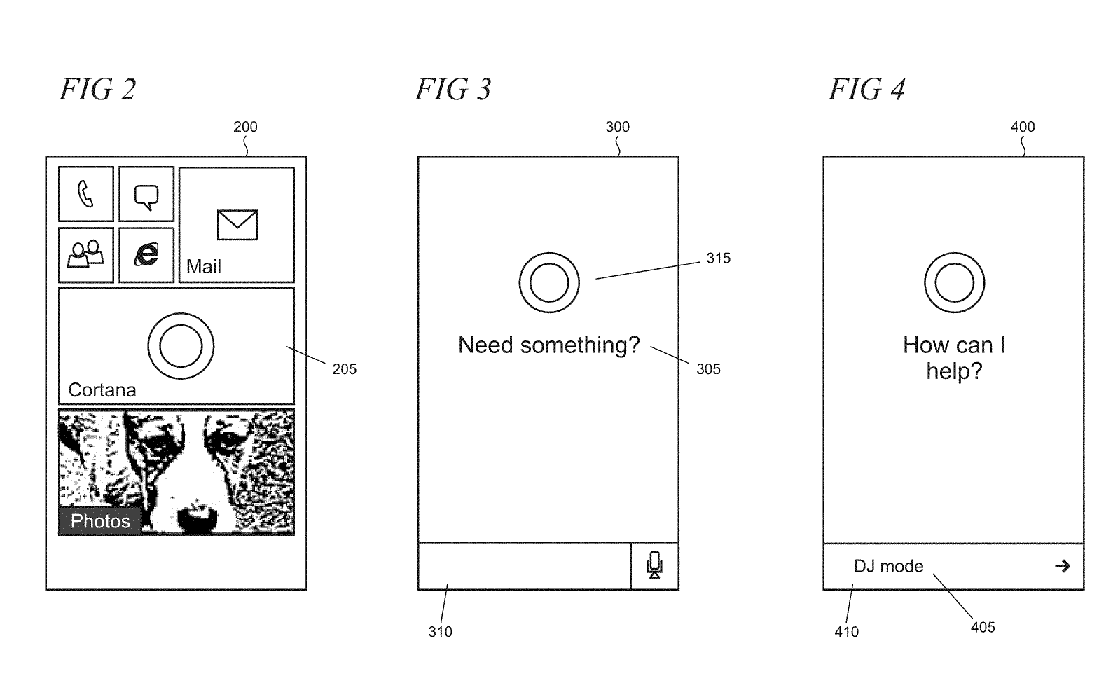

An instance of the digital assistant 112 can be exposed to the user 105 through a graphical user interface (GUI) that is displayed on a device 110. For example, FIGS. 2, 3, and 4 show various illustrative screen captures of GUIs that may be utilized in the present digital assistant integration with music services. It is noted that the particular GUIs displayed in the drawings can vary from what are shown according to the needs of a particular implementation. GUI 200 in FIG. 2 shows the digital assistant (named “Cortana” in this example) represented by a tile 205 that is displayed along with tiles representing other applications, features, functions, or user experiences on a start screen of a device 110. The digital assistant may also be configured to be launched from any location within any GUI on the device, or from within any current user experience. For example, the user 105 can be on a phone call, browsing the web, watching a video, or listening to music, and simultaneously launch the digital assistant from within any of those experiences. In some cases, the digital assistant can be invoked or launched through manipulation of a physical or virtual user control, and/or by voice control/command and/or sensed gesture in other cases.

When the user invokes the digital assistant, for example, by touching the tile 205 or by invoking a voice command or gesture, a UI 300 shown in FIG. 3 is displayed on the device 110 that includes a text string 305 that asks the user if something is needed. In alternative implementations, text to voice translation can be employed so that an audio message can be played in place of, or to supplement the text string 305. As shown, the GUI includes a box 310 that is configured for showing a textual representation of a received voice command/control or other user input.

One or more graphic objects 315 can be displayed on the UI 300 to represent the digital assistant to the user. The graphic object 315 in this example is a circular shape that can be animated so that, for example, it changes its shape, color, transparency, motion, or appearance as the digital assistant performs tasks, provides information, interacts with the user, etc.

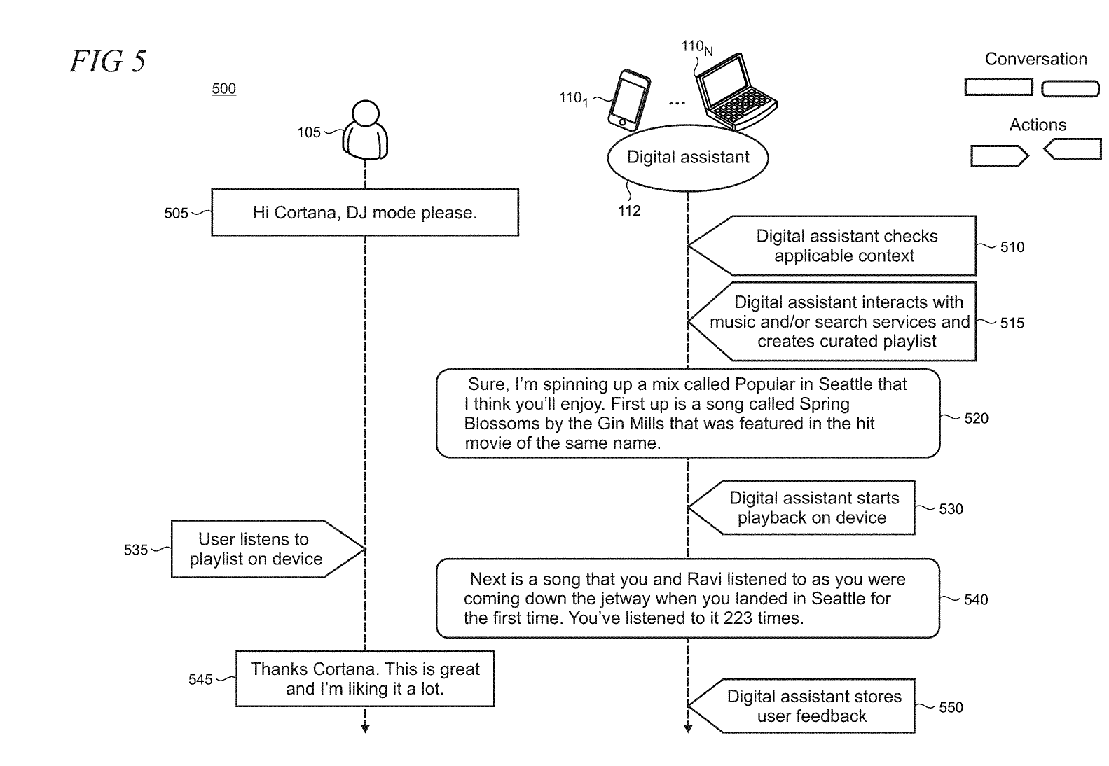

As shown in the UI 400 in FIG. 4, the user has input the string “DJ mode” 405 into the box 410 using, for example, keypad input on a physical or virtual keypad, gesture, or voice. In response to the input, the digital assistant can perform in a DJ mode of operation on the device, in which the digital assistant can curate personalized listening experiences for the user based on available context, user intentions, usage history, and/or preferences, as shown in the use scenarios in FIGS. 5-11 and described in the accompanying text.

FIG. 5 shows a transcript 500 of a first illustrative user experience with a digital assistant. In the transcripts that follow, conversation between the user 105 and the digital assistant are indicated by blocks and actions are indicated by flags. In this user experience, the user 105 invokes an instance of digital assistant 112 on one of her devices 110 using a natural language input as shown at block 505. In response to the user's input, the digital assistant launches into DJ mode and checks current context that is associated with the user at flag 510 (current context can pertain to the user herself, her devices 110, members of her social graph, their devices, etc.). As noted above, the digital assistant can use applicable context when curating a personalized playlist, for example, or when taking other actions.

At flag 515, the digital assistant can interact with either or both the music and search services to create a curated and personalized playlist in view of the user's request and available context. A curated user experience, as that term is used herein, may refer to an experience in which the digital assistant presents and paces the content and experiences in an organized and cohesive manner in which the transitions between presentations are controlled. The pacing and timing of presentation can be performed, for example, to create a sense of drama, elicit a laugh from the user, create a particular mood or ambiance, or otherwise engage and stimulate the user. Thus, the digital assistant can determine what content is included in a playlist and the order in which it is presented that is personalized to the user's tastes and interests. In addition, commentary and information pertaining to the content can be provided in a curated user experience, for example, using voice overs and other audio and/or graphics and video rendered on the device display.

The curation is personalized to the user to provide relevant context and background to the user to help frame the content against her own experiences and interests and/or that of her social graph. For example, curation can provide information about songs, artists, genres, trivia, fun facts, news and current events, popularity, games, related artists and genres, and the like. The curation can also provide tie-ins to related events, content, promotions, and/or other experiences such as live concert performances, links to lyrics and/or videos, upcoming television or web programming regarding an artist, contests and giveaways, and the like. The curation may also include recommendations and suggestions that are provided using audio and/or graphics/video to help the user discover new content and experiences of interest, or rediscover old content and experiences.

The curation can also include information and experiences that are specific to the user. For example, the digital assistant can introduce content in a personalized playlist and indicate how often the user has played it in the past and the context for previous playbacks (e.g., when, where, and with whom). Other examples of personalization may include content ratings, comments, suggestions, and recommendations from the user's friends and/or other members of her social graph.

In this example, the applicable context includes the user's history of interactions with the digital assistant and applications, and the user's current location. The digital assistant applies intelligence to determine that this user wants to listen to a personalized playlist when she says “DJ mode” and that she enjoys particular artists and genres based on her past interactions with the digital assistant and with the music service and other media applications. The digital assistant uses her current location obtained from device sensors such as GPS and map data from a mapping application or services when curating the playlist. The digital assistant provides audio commentary at block 520 to introduce the curated playlist and starts playback on the user's device at flag 530. The user listens to the playlist at flag 535, and the digital assistant, at block 540, provides additional commentary that includes information that is specific to the user (in this example, playback count).

The user provides feedback at block 545 which the digital assistant stores at flag 550 for future use. For example, the feedback from the user in this example can help the digital assistant refine the curation methodologies employed for the user. The user feedback may be positive, as in this example, or be negative or corrective such as “this is good Cortana, but please more music and less talk” which the digital assistant can use to tailor the curation of future playlists. The digital assistant can typically note the applicable context that is associated with the user feedback and store and use that information as well. For example, if the user provides feedback saying “more high energy music please, Cortana” during a workout when she is pumped up with a high heart rate, then the digital assistant may curate up-tempo music for the user's next workout, but not necessarily for other contexts in which the user may be more inclined to hear relaxing music (such as at bedtime).

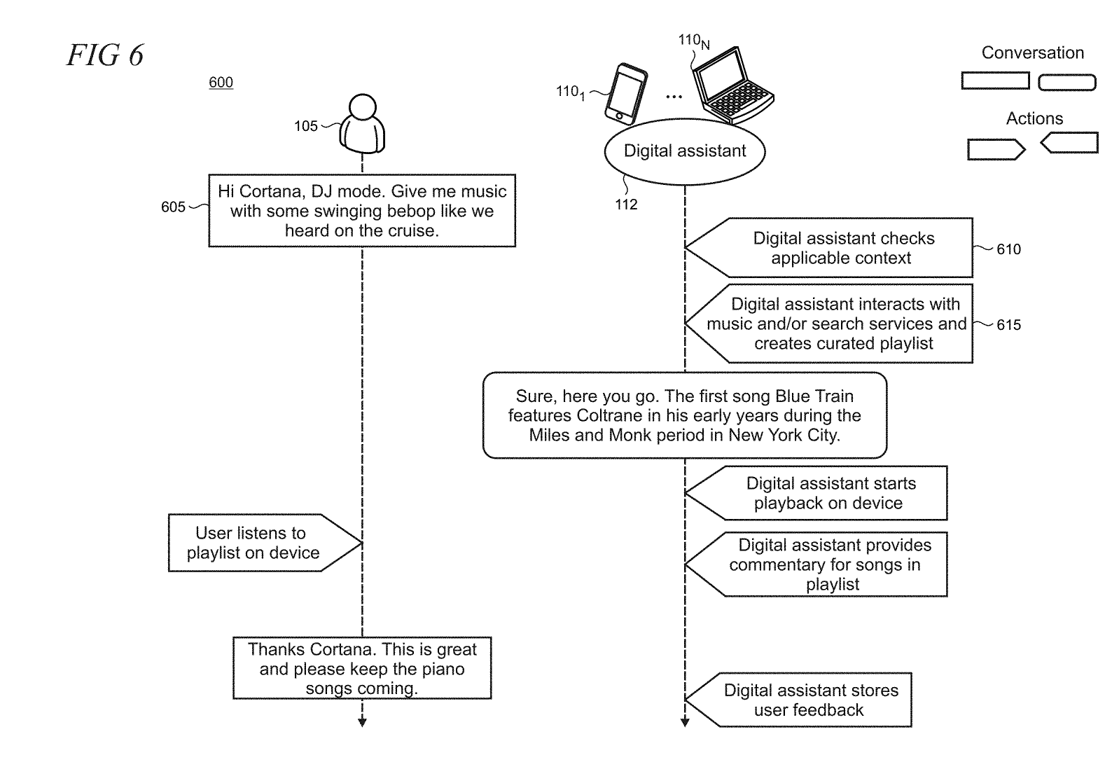

FIG. 6 shows a transcript 600 of a second illustrative user experience with a digital assistant. The user invokes DJ mode at block 605 in order to identify a particular music genre using context that is specific to the user instead of providing an artist name, song title, or other identifying criteria. The digital assistant checks applicable context at flag 610 to determine, among other things, the event to which the user is referring. For example, the digital assistant can interact with the user's calendar or scheduling application to find the event and then correlate the event with the music that was played at that time to locate a desired song. At flag 615, the digital assistant can interact with either or both the music and search services to create a curated and personalized playlist in view of the user's request and the available context.

As shown in FIG. 6, the digital assistant plays the playlist on the user's device and adds commentary in a similar manner as provided by a radio host or DJ, but with the added dimension that the commentary can also be specifically personalized to the user, as discussed above. The digital assistant can store feedback regarding the playlist from the user and use the feedback when generating future curated listening experiences.

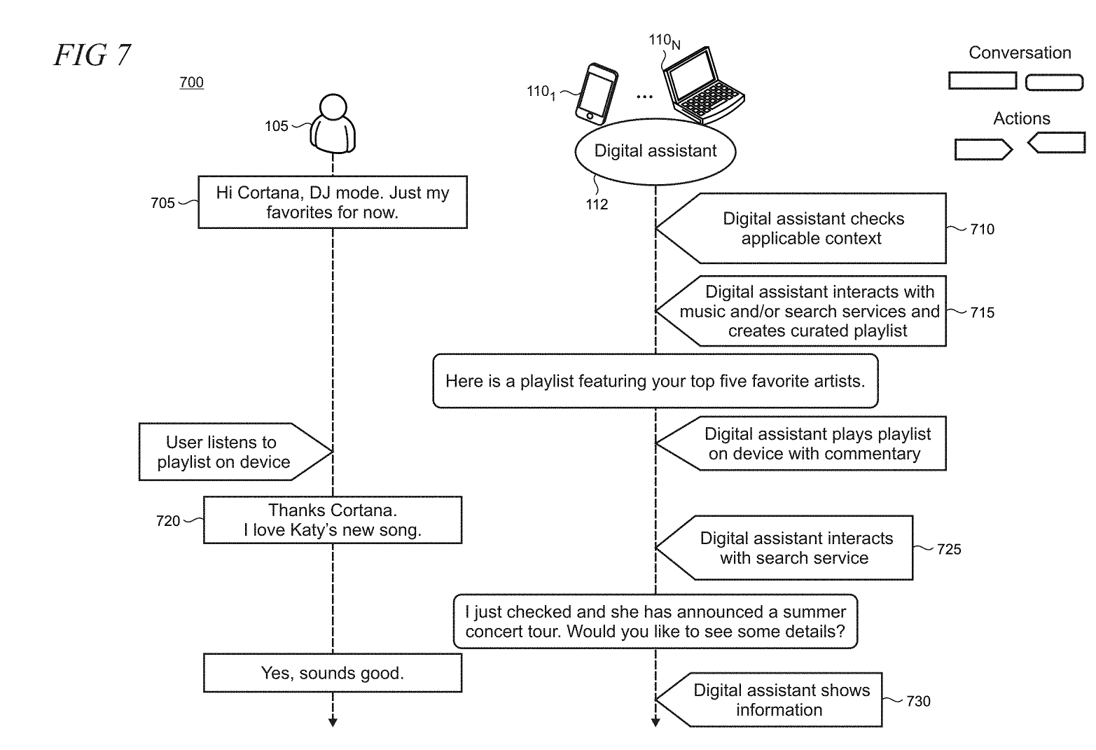

FIG. 7 shows a transcript 700 of a third illustrative user experience with a digital assistant. The user invokes DJ mode at block 705 and the digital assistant checks applicable context and interacts with the music or search services to create a curated playlist, as respectively shown at flags 710 and 715. When the user remarks in block 720 that she likes a particular song on the playlist, the digital assistant interacts with the search service, at flag 725, to look up relevant information about the artist. In this example, the digital assistant finds live performance information that it can graphically render on the device display, at flag 730. Alternatively, the digital assistant can read the information to the user. The digital assistant can also take actions on behalf of the user to navigate to a ticket website, for example, and complete a ticket purchase for the concert (not shown in the drawing).

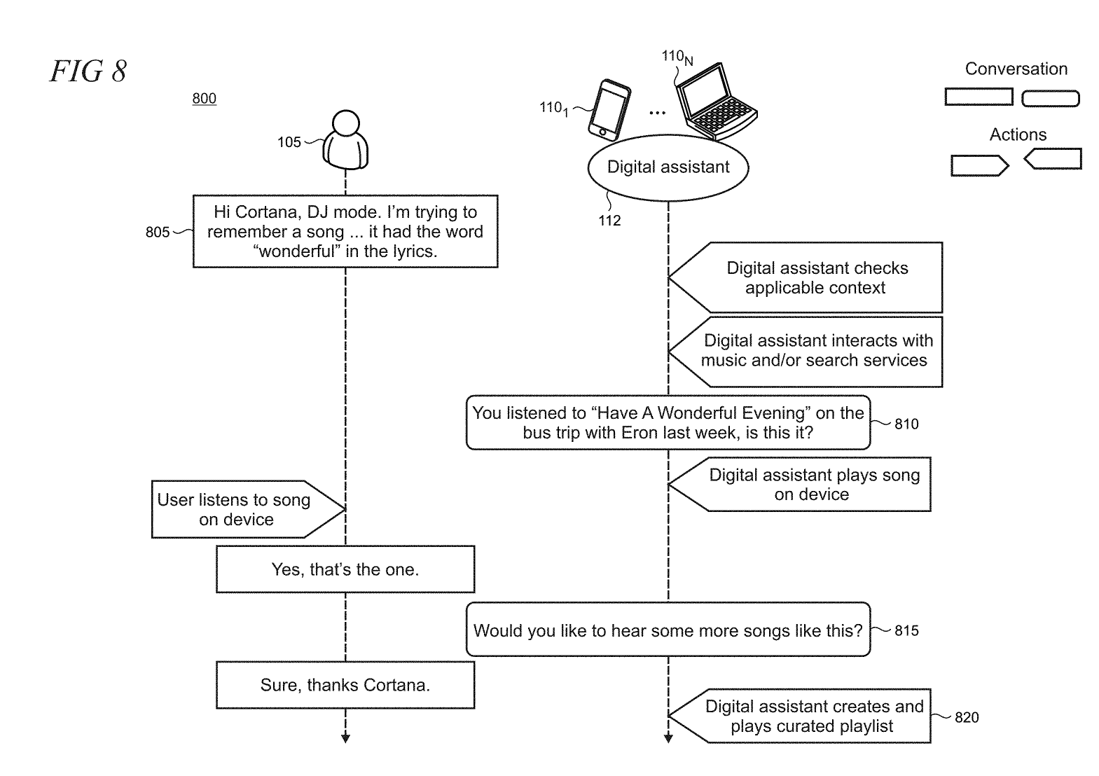

FIG. 8 shows a transcript 800 of a fourth illustrative user experience with a digital assistant. The user invokes DJ mode and looks to identify a song based on lyric content at block 805. As in the previous examples, the digital assistant checks available context and interacts with the music and/or search services. In this example, the digital assistant is not able to disambiguate the song based solely on the information provided from the user. Thus, at block 810 the digital assistant applies context to help identify the content and then asks the user to confirm that its identification is correct. In this example the digital assistant employs the user's music playback history to identify a possible candidate song. After the user confirms that the song picked by the digital assistant is the sought-after content, the digital assistant offers to create a customized playlist based on the identified song at block 815. The digital assistant creates and plays the curated playlist using resources from the music and/or services as needed at flag 820.

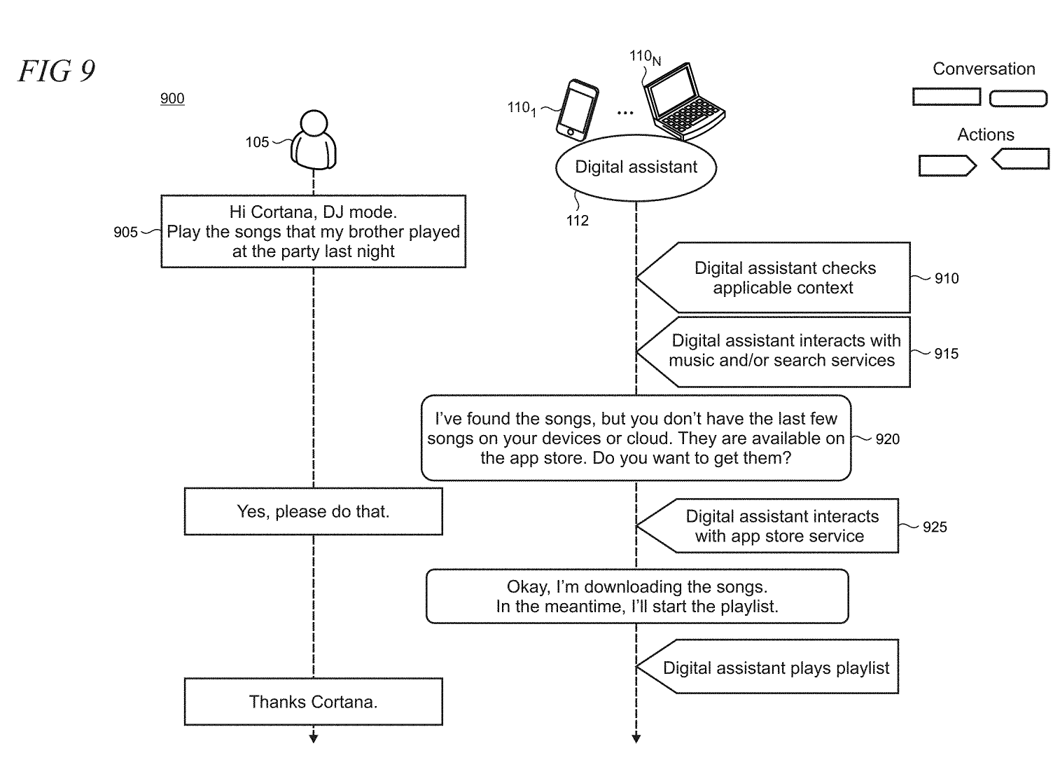

FIG. 9 shows a transcript 900 of a fifth illustrative user experience with a digital assistant. The user invokes DJ mode at block 905 and looks to find music based on contextual information. In this example, the context is an event in which a member of the user's social graph (her brother in this example) played a particular playlist. The digital assistant checks applicable context at flag 910 and interacts with the music and/or search services at flag 915. For example, the digital assistant can interact with the user's calendar or scheduling application to identify the referenced event. The digital assistant may also interact with the brother's device and/or digital assistant to identify the content that was played at the event. Alternatively, the digital assistant may interact with a music service associated with the user's brother to find the sought-after playlist, or check a social media application or other application in which the user's brother may have posted the playlist for the party.

At block 920, the digital assistant informs the user that it found the playlist, but the user does not have access to some of the songs. In response to input from the user, the digital assistant interacts with an application (app) store service to obtain the missing content, as shown at flag 925. In alternative examples, the digital assistant may suggest to the user that she take advantage of a free trial to a streaming music service, for example, to listen to the desired songs.

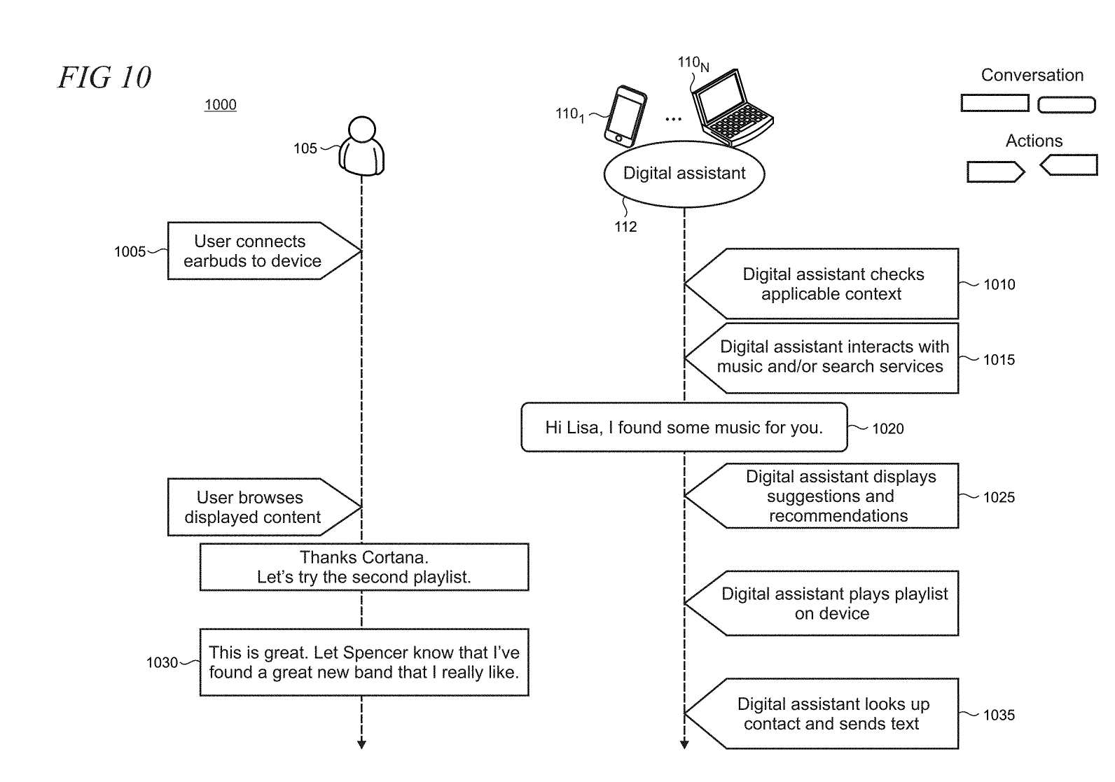

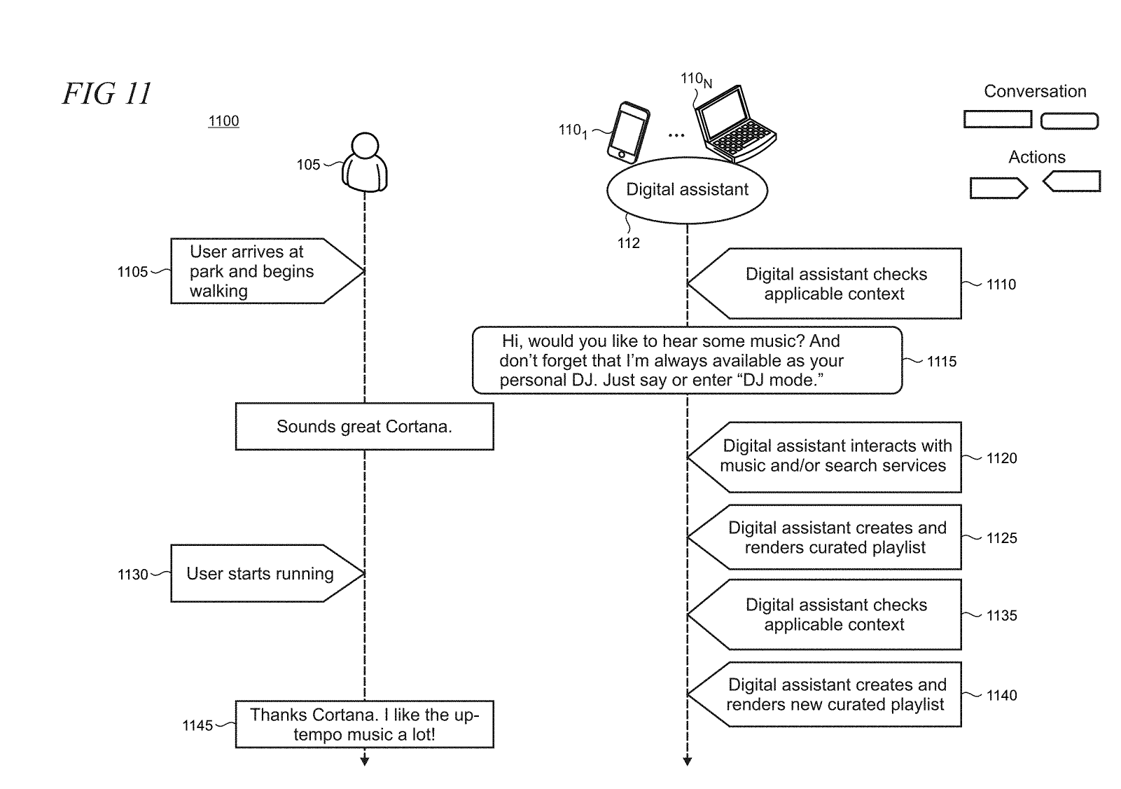

FIG. 10 shows a transcript 1000 of a sixth illustrative user experience with a digital assistant. In this example, the user does not explicitly invoke the DJ mode of the digital assistant. Instead, as shown at flag 1005, the user connects her earbuds to her device. Device state or configuration is an example of context that the digital assistant may monitor. In response to change in device state (i.e., the connection of the earbuds), the digital assistant checks available context at flag 1010 and interacts with the music and/or search services at flag 1015.

Depending on the context, the digital assistant may proactively interact with the user to suggest an opportunity for a listening experience. For example, if the user usually listens to music at a particular location or at a particular time of day, then those contextual data points may indicate to the digital assistant that a listening experience recommendation is appropriate. If, however, the user's history indicates a tendency to consume video or play games when the earphones are connected, then these contextual data points may lead the digital assistant to a different conclusion. The contextual data that the digital assistant uses in a given use scenario, and the weighting given to any particular data points, can vary by implementation.

In this example, the applicable context indicates to the digital assistant that a proactive music recommendation is appropriate and the digital assistant reaches out to the user using audio at block 1020 and/or graphics. The digital assistant displays some recommended curated playlists at flag 1025. In response to user input at block 1030, the digital takes an action on behalf of the user at flag 1035 (i.e., looks up a contact from the user's address book and sends a text message to the contact).

FIG. 11 shows a transcript 1100 of a seventh illustrative user experience with a digital assistant. This user experience is another example of how the digital assistant can proactively look for opportunities to recommend a listening experience to the user. In this example, the user arrives at a park and begins walking at flag 1105. The digital assistant checks applicable context at flag 1110, for example, including time of day, location, and motion of the user through device sensors such as GPS sensor and accelerometer. The digital assistant can also examine contextual data including past user behaviors at this location and time of day and biometric data from the accessory device 116 (FIG. 1). Here the digital assistant determines from the applicable context that a proactive recommendation is appropriate and reaches out to the user using audio or rendered graphics at block 1115.

The digital assistant interacts with the music and/or search services at flag 1120 to create a curated playlist at flag 1125. Recognizing from the motion and biometric sensors that the user is casually strolling along the park, the digital assistant curates a personalized playlist of songs in a soft jazz genre that the user has liked in the past. When the user's context changes at flag 1130 (i.e., the user commences a vigorous run), the digital assistant can react to the changing context at flag 1135 and generate a new curated playlist at flag 1140 which includes up-tempo music to help motivate the user as she runs. Feedback from the user as to the curated playlist at block 1145 can be stored by the digital assistant and utilized to refine the curation methodologies for future instances of playlist generation.

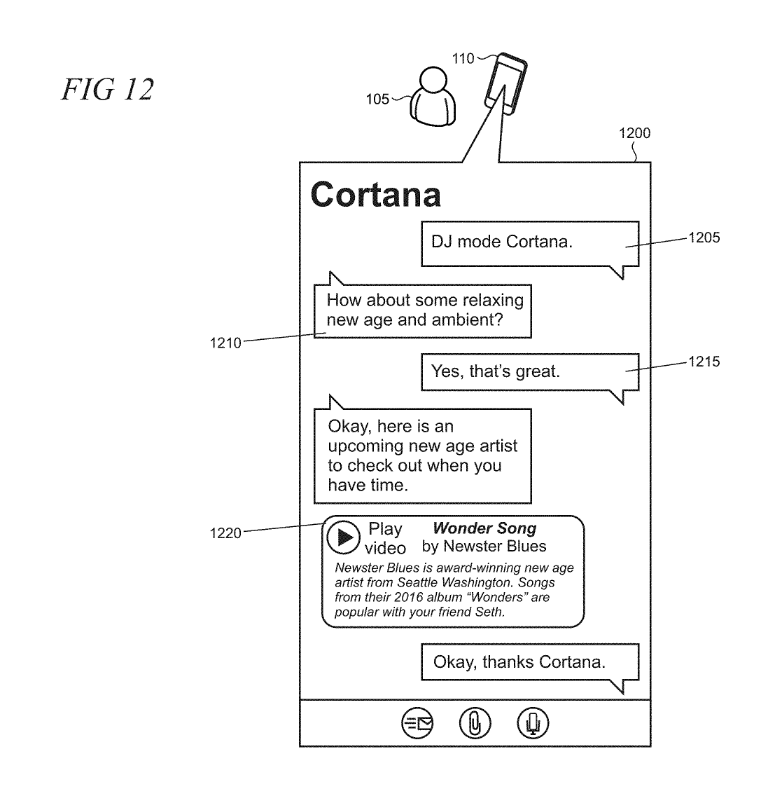

FIG. 12 shows an illustrative GUI 1200 rendered on a computing device that shows interactions between a device user 105 and a digital assistant (e.g., digital assistant 112 in FIG. 1). In this example, the user interacts with the digital assistant using text messages as if the digital assistant were a regular human contact of the user. The user's texts are shown on the right side of the GUI and the texts generated by the digital assistant are shown on the left side. The user invokes DJ mode in text 1205. The digital assistant can check applicable context and interact with the music and/or search services in response to the DJ mode trigger. Based on context, the digital assistants asks the user if she wants to hear a particular recommended music genre in text 1210.

Based on the user's affirmation in text 1215, and seeing that the user has nothing scheduled in her calendar and may be open to discovering new artists, the digital assistant proactively suggests that the user watch a music video associated with an artist in the genre and provides a window 1220 from which the user may launch the video.

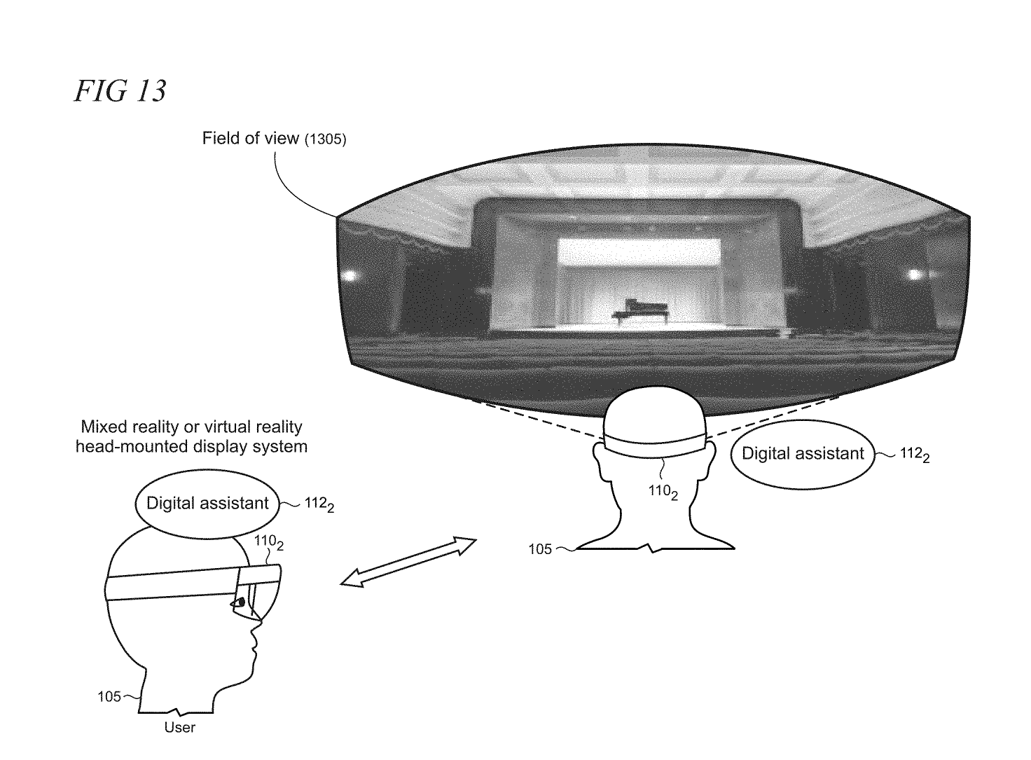

FIG. 13 shows an illustrative user experience for a user of an HMD device 110 that may be configured to render mixed reality or virtual reality images within a field of view (FOV) 1305. The HMD device supports an instance of a digital assistant 112 that may be configured to provide a curated user experience for the HMD device user 105. In this example, the FOV 1305 renders a virtual concert hall environment that is associated, for example, with a playlist of classical music content. As the virtual concert environment is rendered, the digital assistant can play the playlist and provide curation to support the rendered visual and audio content. The digital assistant can provide commentary to describe songs in the playlist and/or the rendered virtual reality environment in the FOV. For example, the digital assistant can provide audio through the HMD device speakers saying “as the concert hall starts to fill, the atmosphere is electric in anticipation of Brandon Carr's performance of selected Mozart piano concertos. The pianist is returning to the stage after a two-year hiatus following the birth of his son. An electronic arrangement of the first movement was used on the hit TV series ‘Applesauce Kids . . . ’”

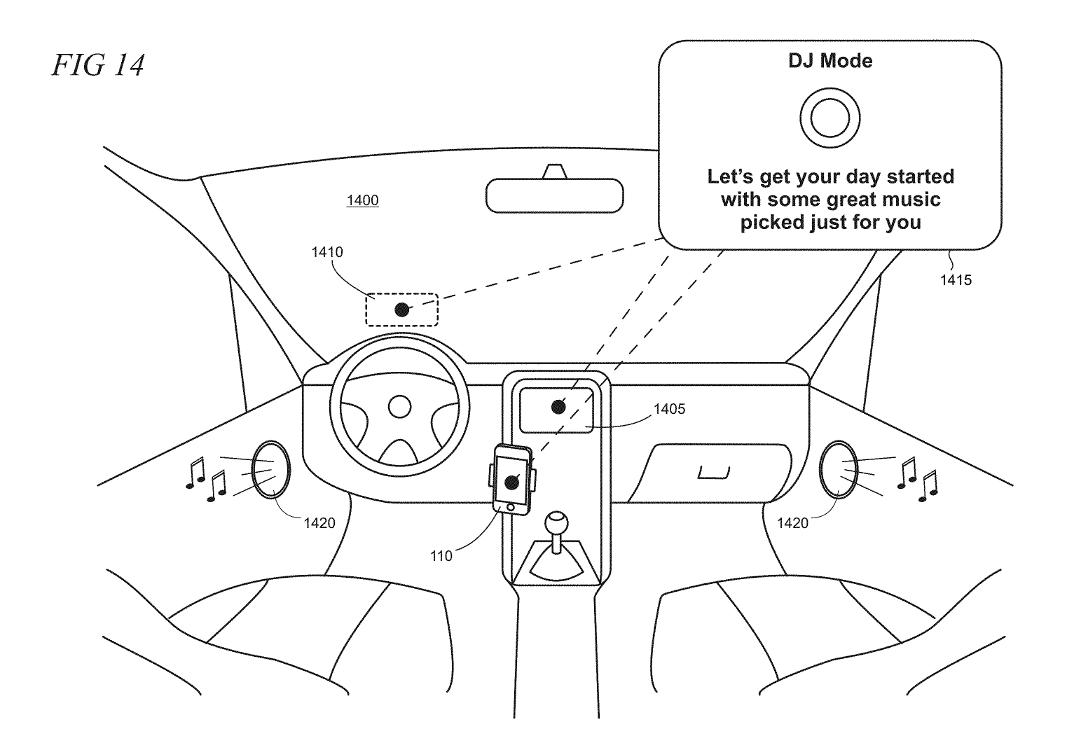

FIG. 14 shows an illustrative example of a digital assistant operating in a car 1400. In this example, when the user enters her car, a digital assistant operating on her smartphone device 110 can automatically interoperate with various ones of the car's electronic systems such as information system 1405 or heads-up display 1410 and launch into DJ mode. A graphic 1415 can be displayed to the user on the device 110 and/or the systems 1405 and 1410. The digital assistant can collect and apply available context to generate and play a personalized playlist of curated audio content on the car's audio system 1420.

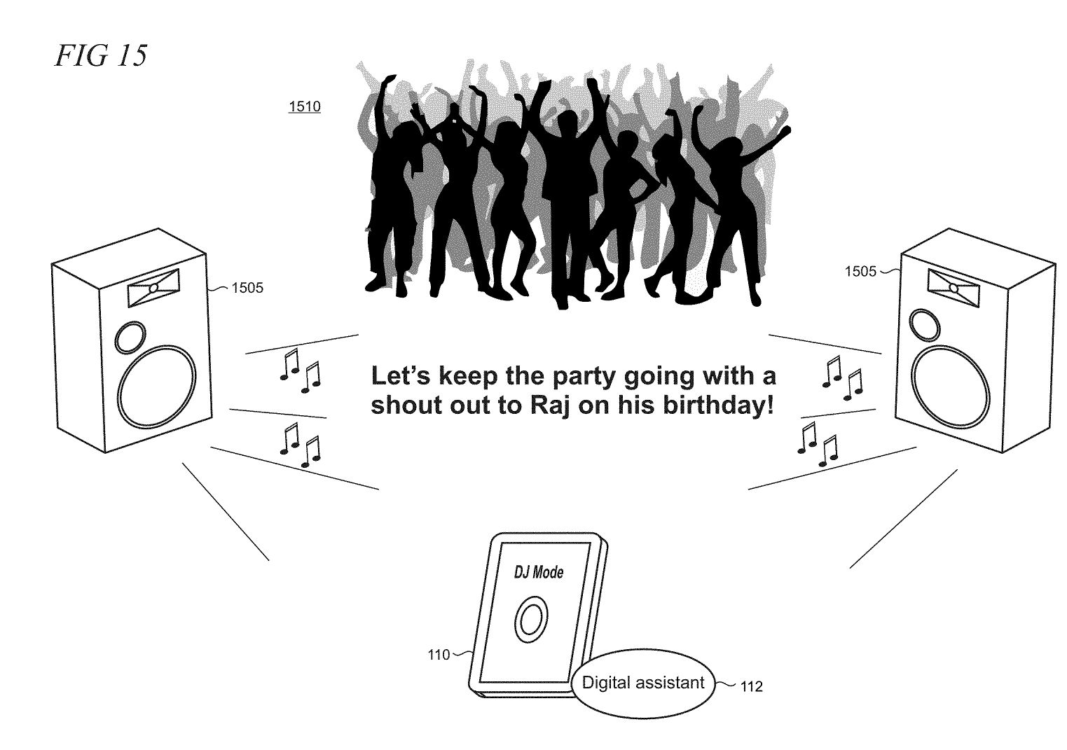

FIG. 15 shows an illustrative example of a digital assistant 112 operating in DJ mode on a device 110 at an event. The device 110 is coupled to an external audio system 1505 to play a curated playlist of music for the event attendees 1510. The digital assistant can generate a playlist that is customized to the event based on the event type (e.g. birthday party, office party, corporate event/show, school event, prom, wedding, charity event, etc.), characteristics of the attendees (e.g., adults, children, mixed ages, etc.), an event theme, or the like. In some implementations, the digital assistant can interoperate with digital assistants that are running on other devices to crowd source context that is relevant across a range of event attendees. In that way, the playlist can reflect the tastes of the group as a whole, identify content that is popular with the group, and provide targeted curation. For example, the digital assistant can identify individuals for special recognition or “shout outs” so that the curation is meaningful and special for the event.

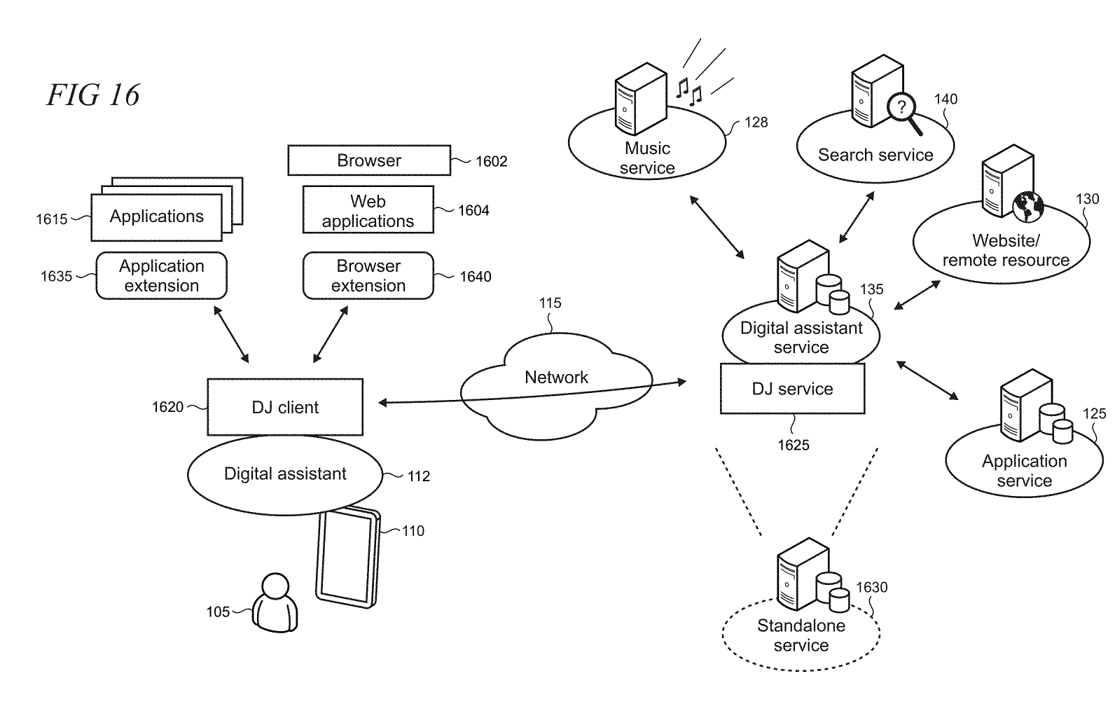

Turning now to various implementation details for the present digital assistant integration with music services, as shown in FIG. 16, a device 110 can include local components such as a browser 1602 into which web applications 1604 can render and/or one or more applications 1615 that can facilitate interaction with one or more websites and remote application services. For example, in some use scenarios, a user 105 may launch a locally executing application that communicates over the network 115 to an application service 125 (FIG. 1) in order to retrieve data and obtain services to enable various features and functions, provide information, and/or support user experiences that can be supported on various ones of the user interfaces on a local device 110 such as GUIs and audio user interfaces. In some use scenarios and/or at different times, an application 1615 may operate locally on the device without needing to interface with a remote service.

The local digital assistant 112 interoperates in this illustrative example with a local DJ client 1620 that typically communicates over the network 115 with a remote DJ service 1625 that is supported by the remote digital assistant service 135. In this particular example, the DJ client 1620 is configured to interact with the digital assistant 112, and the DJ service 1625 is supported by the digital assistant service 135. However, the DJ 1620 client can be separately instantiated from the digital assistant in some cases. In addition, the DJ service 1625 may be optionally provided in whole or part (as indicated by the dashed lines) by a standalone service 1630 or be incorporated into another service. The DJ client may interact with applications through one or more application extensions or other suitable interface to enable application content and user experiences to be accessed by the DJ client 1620. Similarly, the DJ client may interact with the browser 1602 and web applications 1604 through a browser extension 1640 or other suitable interface to enable web applications content and user experiences to be accessed by the DJ client 1620.

In some implementations, the DJ client 1620 can be arranged as a standalone component that provides features and/or services without interacting with a remote resource or service (aside from periodic updates, and the like). Typically, the interoperability between the DJ system and the digital assistant is implemented so that the system can render user experiences, features, and content using the digital assistant with a similar and consistent sound, look, and feel in most cases so that transitions between the system and the digital assistant are handled smoothly and the experiences are rendered seamlessly to the user.

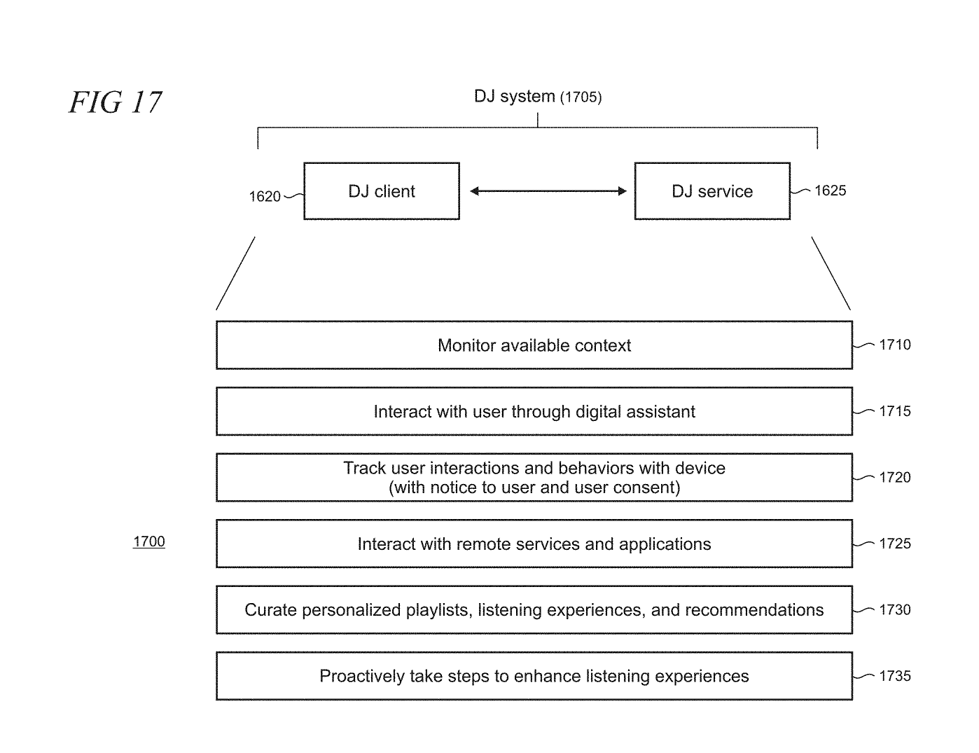

The DJ client 1620 and DJ service 1625 are collectively referred to herein as a DJ system 1705, as shown in FIG. 17. The DJ system 1705 can expose a variety of features and capabilities according to the requirements of a particular implementation of the present digital assistant integration with music services. For example, as shown in taxonomy of functions 1700, the DJ system 1705 can monitor available context 1710, interact with the user through the digital assistant 1715, track user interactions and behaviors with the device 110 (typically such tracking is performed with notice to the user and user consent) 1720, interact with remote services 1725 (e.g., the music service 128 and search service 140), curate personalized playlists, listening experiences, and recommendations 1730, and proactively take steps to enhance listening experiences 1735. The functions 1700 are illustrative and not all the functions need to be performed by the DJ system 1705 in every implementation.

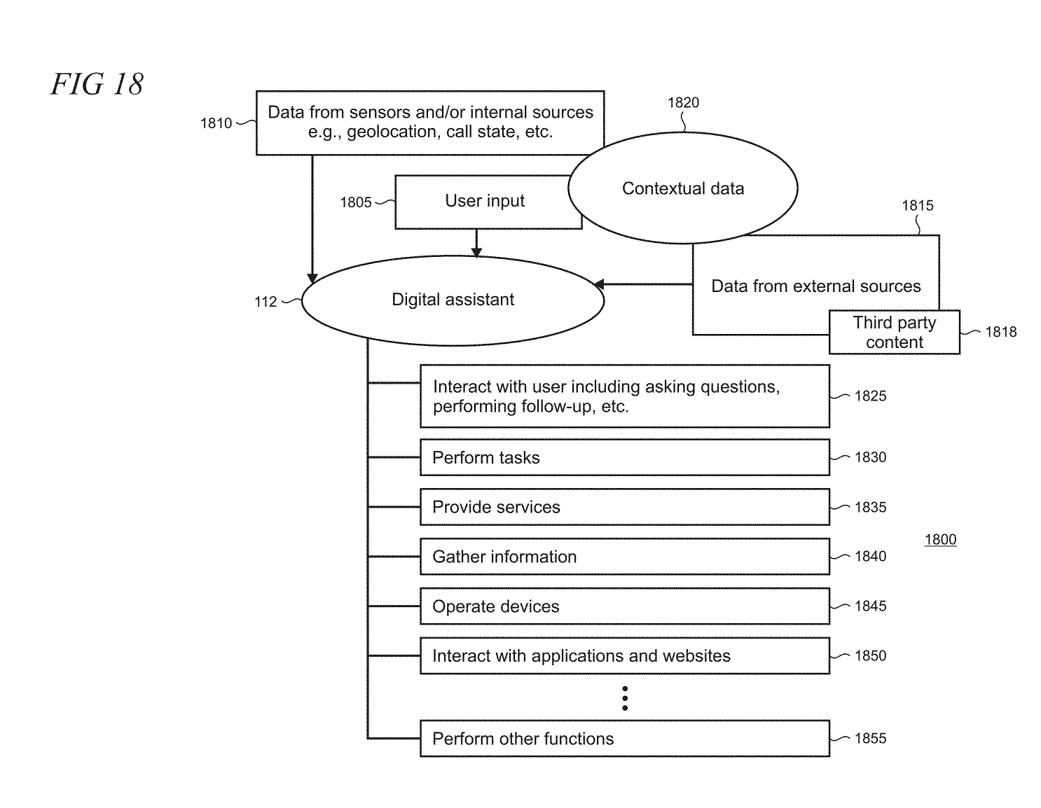

FIG. 18 shows an illustrative taxonomy of functions 1800 that may typically be supported by the digital assistant 112 either natively or in combination with an application 1615 (FIG. 16), web application 1604, browser 1604, or the DJ system 1705 (FIG. 17). Inputs to the digital assistant 112 typically can include user input 1805, data from device sensors and/or internal sources 1810, and data from external sources 1815 which can include third-party content 1818. For example, data from internal sources 1810 may include the current location of the device 110 that is reported by a GPS (Global Positioning System) component on the device, or some other location-aware component or sensor. The externally sourced data 1815 may include data provided, for example, by external systems, databases, services, and the like.

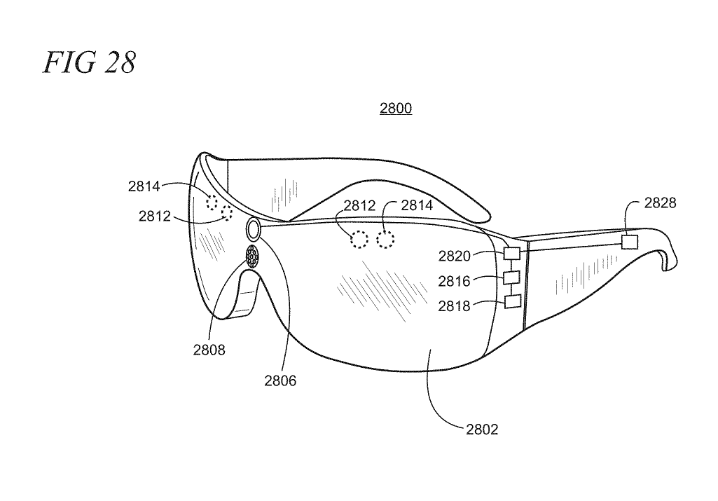

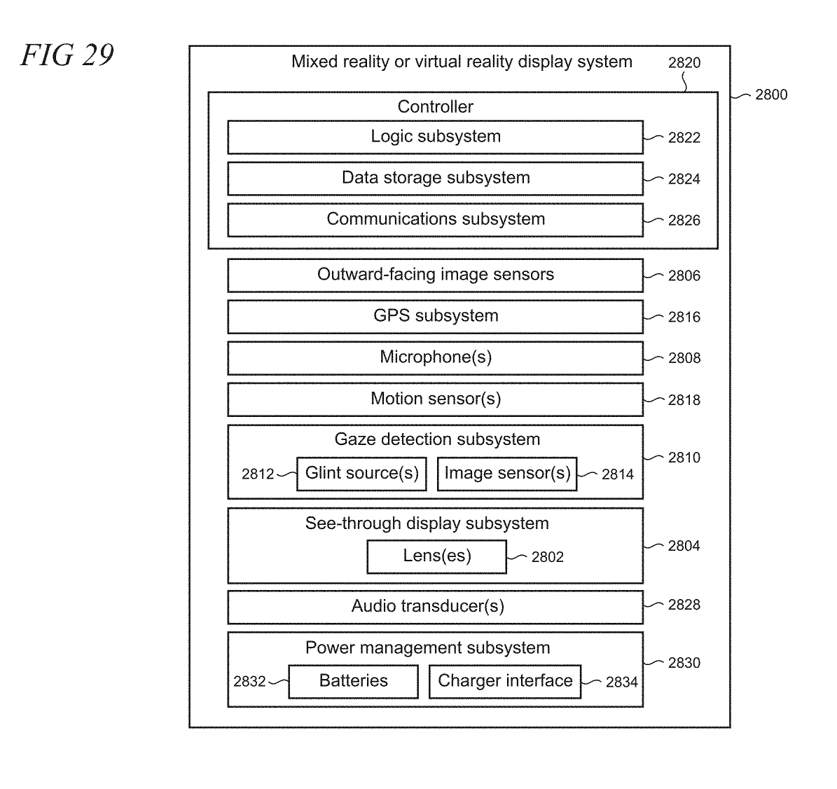

The various inputs can be used alone or in various combinations to enable the digital assistant 112 to utilize contextual data 1820 when it operates. Contextual data is data that provides relevant context about a person (e.g., the user), an entity (e.g., one or more devices), or event and can be collected using a sensor package on a device that is configured to sense and analyze data about the user or device environmental surroundings. Sensors in the sensor package may include, for example, camera, accelerometer, location-awareness component, thermometer, altimeter, heart rate sensor, barometer, microphone, or proximity sensor, as described in more detail in the text below accompanying FIGS. 28 and 29. Contextual data can also be collected from stored data that is associated with a person, entity, or event.

Contextual data can include, for example, time/date, the user's location, speed, acceleration, and/or direction of travel, environmental conditions (e.g., altitude, temperature, barometric pressure), user's physiological state, language, schedule, applications installed on the device, the user's preferences, the user's behaviors (in which such behaviors may be monitored/tracked with notice to the user and the user's consent), stored contacts (including, in some cases, links to a local user's or remote user's social graph such as those maintained by external social networking services), call history, messaging history, browsing history, device type, device capabilities, communication network type and/or features/functionalities provided therein, mobile data plan restrictions/limitations, data associated with other parties to a communication (e.g., their schedules, preferences, etc.), and the like.

As shown, the digital assistant functions 1800 illustratively include interacting with the user 1825 (through a natural language user interface and other graphical interfaces, for example); performing tasks 1830 (e.g., making note of appointments in the user's calendar, sending messages and emails, etc.); providing services 1835 (e.g., answering questions from the user, mapping directions to a destination, setting alarms, forwarding notifications, reading emails, news, blogs, etc.); gathering information 1840 (e.g., finding information requested by the user about a book or movie, locating the nearest Italian restaurant, etc.); operating devices 1845 (e.g., setting preferences, adjusting screen brightness, turning wireless connections such as Wi-Fi and Bluetooth on and off, communicating with other devices, controlling smart appliances, etc.); interacting with applications, websites, and remote services and resources 1850; and performing various other functions 1855. The list of functions 1800 is not intended to be exhaustive and other functions may be provided by the digital assistant 112, applications, web applications, and/or services/remote resources as may be needed for a particular implementation of the present digital assistant integration with music services.

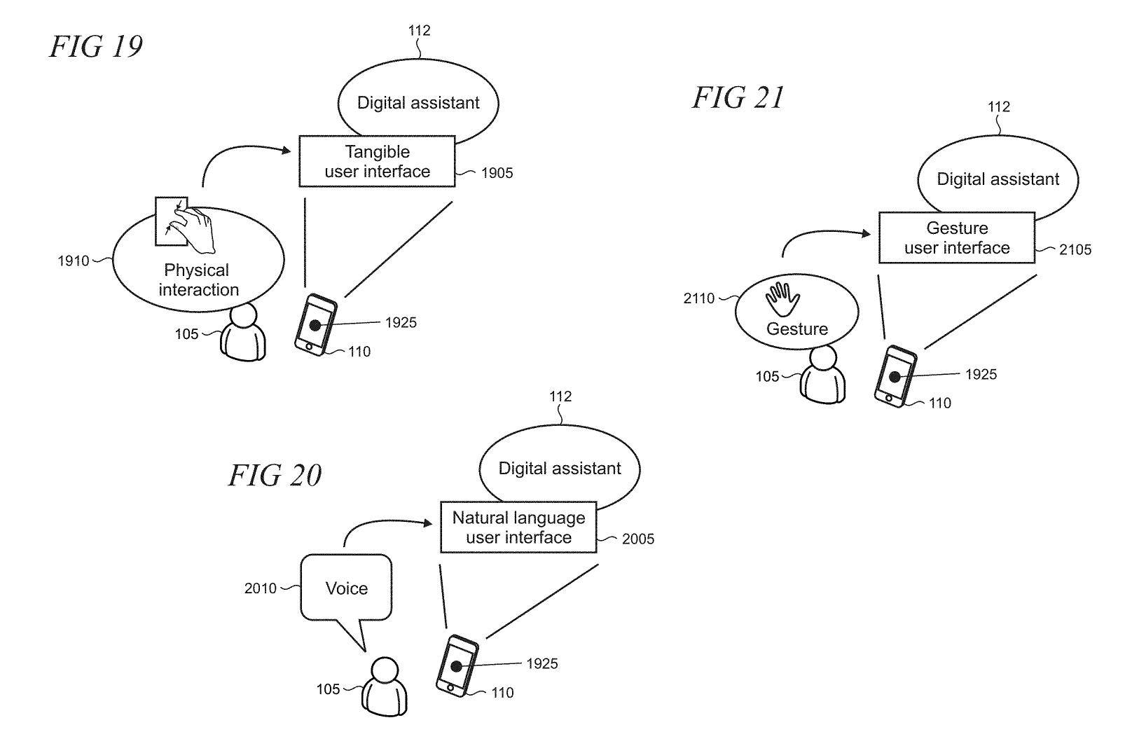

A user can typically interact with the digital assistant 112 in a number of ways depending on the features and functionalities supported by a given device 110. For example, as shown in FIG. 19, the digital assistant 112 may expose a tangible user interface 1905 that enables the user 105 to employ physical interactions 1910 in support of user experiences on the device 110. Such physical interactions can include manipulation of physical and/or virtual controls such as buttons, menus, keyboards, etc., using touch-based inputs like tapping, flicking, dragging, etc. on a touchscreen supporting a graphical user interface 1925, and the like.

In some implementations, the digital assistant 112 may expose a natural language user interface 2005 shown in FIG. 20, or alternatively a voice command-based user interface (not shown), with which the user employs voice 2010 to provide various inputs to the device 110.

In other implementations, the digital assistant 112 may expose a gesture user interface 2105 shown in FIG. 21 with which the user 105 employs gestures 2110 to provide inputs to the device 110. The gestures 2110 can include touch-based gestures and touchless gestures. It is noted that in some cases, combinations of user interfaces may be utilized where the user may employ, for example, both voice and physical inputs to interact with the digital assistant 112 and the device 110. The user gestures can be sensed using various techniques such as optical sensing, touch sensing, proximity sensing, and the like.

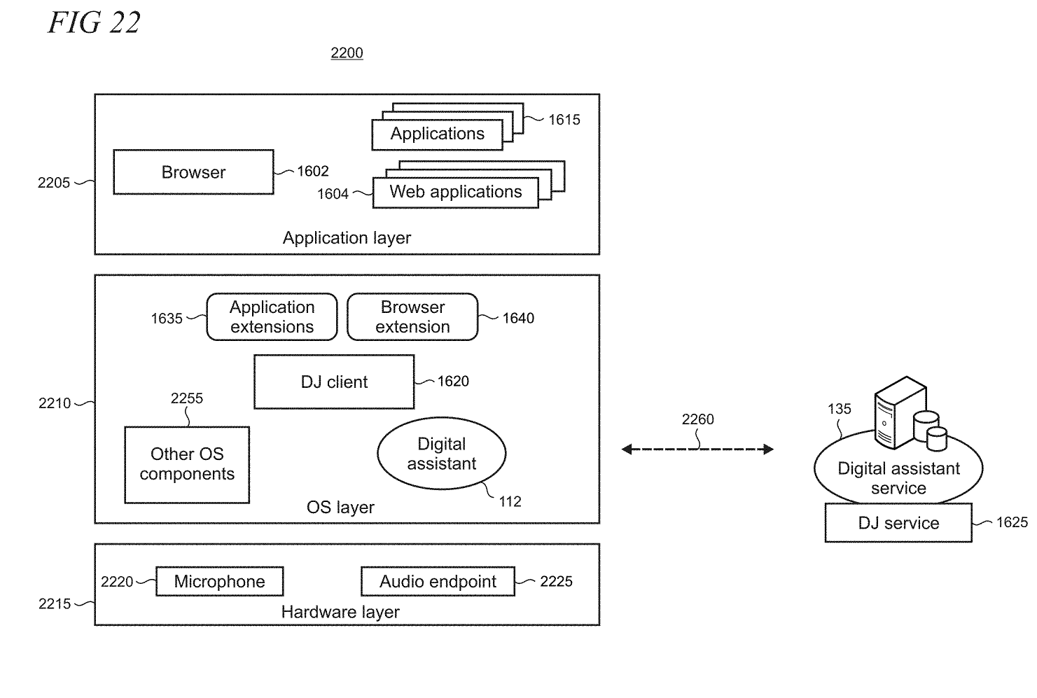

FIG. 22 shows an illustrative layered architecture 2200 that may be instantiated on a given device 110. The architecture 2200 is typically implemented in software, although combinations of software, firmware, and/or hardware may also be utilized in some cases. The architecture 2200 is arranged in layers and includes an application layer 2205, an OS (operating system) layer 2210, and a hardware layer 2215. The hardware layer 2215 provides an abstraction of the various hardware used by the device 110 (e.g., input and output devices, networking and radio hardware, etc.) to the layers above it. In this illustrative example, the hardware layer supports a microphone 2220, and an audio endpoint 2225 which may include, for example, the device's internal speaker, a wired or wireless headset/earpiece, external speaker/device, and the like.

The application layer 2205 in this illustrative example supports the browser 1602 and various applications 1615 and web applications 1604 (productivity, social, entertainment, news and information applications, etc.). The browser and each of the applications may be configured to expose an extensibility functionality through respective application extensions 1635 and browser extension 1640 such as an API (application programming interface), or other suitable components to facilitate interactions with the digital assistant and other components in the OS layer. For example, the extensibility functionality may enable the digital assistant and/or DJ client to access an email application to retrieve the user's emails and read them aloud to the user. The applications are often implemented using locally executing code. However, in some cases, these applications can rely on services and/or remote code execution provided by remote servers or other computing platforms such as those supported by a service provider or other cloud-based resources.

The OS layer 2210 supports the digital assistant 112, the DJ client 1620, the application extensions 1635, the browser extension 1640, and various other OS components 2255. In alternative implementations, the DJ client 1620, the application extensions 1635, and the browser extension 1640 can be optionally instantiated as components in the application layer 2205. In typical implementations, the digital assistant 112 can interact with the digital assistant service 135, as indicated by line 2260. That is, the digital assistant 112 in some implementations can partially utilize or fully utilize remote code execution supported at the service 135, or using other remote resources. In addition, it may utilize and/or interact with the other OS components 2255 (and/or other components that are instantiated in the other layers of the architecture 2200) as may be needed to implement the various features and functions described herein. In some implementations, some or all of the functionalities supported by one or more of the DJ client 1620, the application extensions 1635, and/or the browser extension 1340 can be incorporated into the digital assistant 112 and the particular division of functionality between the components can be selected as a matter of design choice.

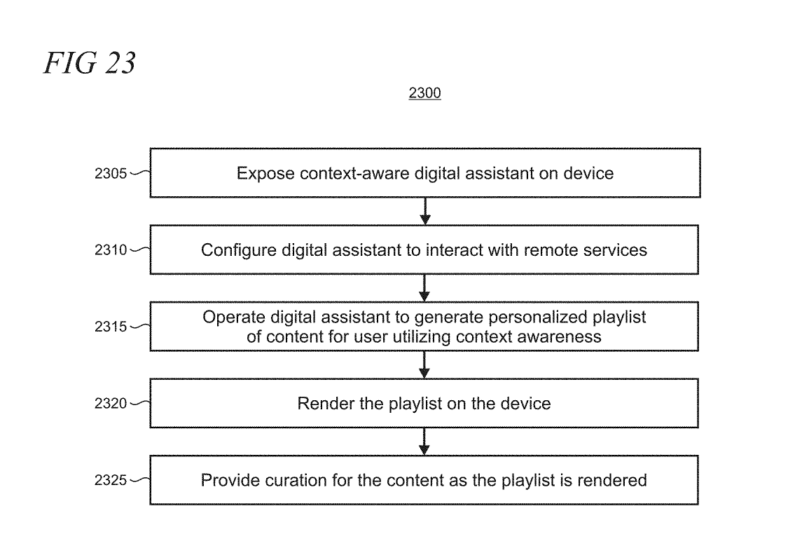

FIG. 23 shows a flowchart of an illustrative method 2300 that may be performed by a computing device (e.g., device 110 in FIG. 1). Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 2305, the device exposes a context-aware digital assistant that maintains context awareness by monitoring user interactions with the device or by accessing contextual data associated with either the user or the device. In step 2310, the digital assistant is configured to interact with services that are remote to the device, including at least a music service or a search service. In step 2315, the digital assistant is operated to generate a playlist of content that is personalized to the user utilizing the context awareness. In step 2320, the playlist is rendered on the device. In step 2325, the digital assistant provides curation for content in the playlist as it is rendered.

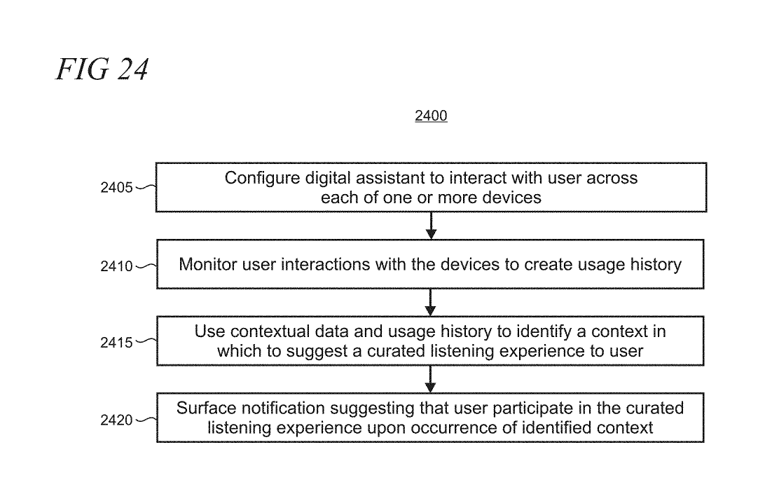

FIG. 24 shows a flowchart of an illustrative method 2400 that may be performed by a computing device (e.g., device 110 in FIG. 1). In step 2405, a digital assistant is configured to interact with a user across each of one or more devices. In step 2410, user interactions with the devices is monitored (typically with notice to the user and consent from the user) to create a usage history. In step 2415, contextual data and usage history is used to identify a context with which to suggest a curated listening experience to the user. In step 2420, a notification of the suggestion to participate in the curated listening experience is surfaced where a curated listening experience comprises a playlist of content in which the digital assistant provides commentary pertaining to the content as the playlist is played on one or more of the devices.

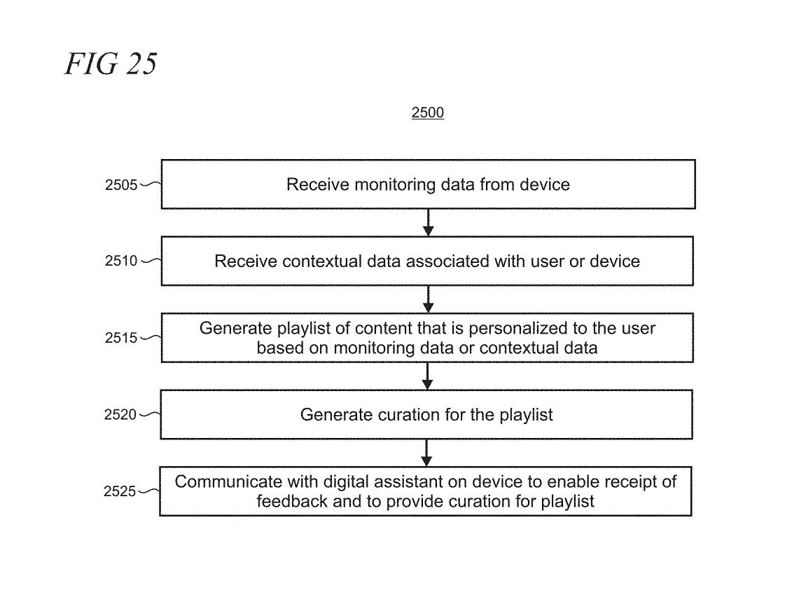

FIG. 25 shows a flowchart of an illustrative method 2500 that may be performed by a server associated with a service (e.g., the digital assistant service 135 in FIG. 1). In step 2505, monitoring data is received from a device in which the monitoring data describes interactions between a user and a device (typically the monitoring data is collected with notice to the user and with user consent). In step 2510, contextual data associated with either the user or the device is received. In step 2515, a playlist of content that is personalized to the user is generated based on the monitoring data and the contextual data. In step 2520, curation for content in the playlist is generated. In step 2525, the server communicates with a digital assistant instantiated on the device to enable the digital assistant to receive user feedback on the personalized playlist and provide curation for the playlist as it is played on the device.

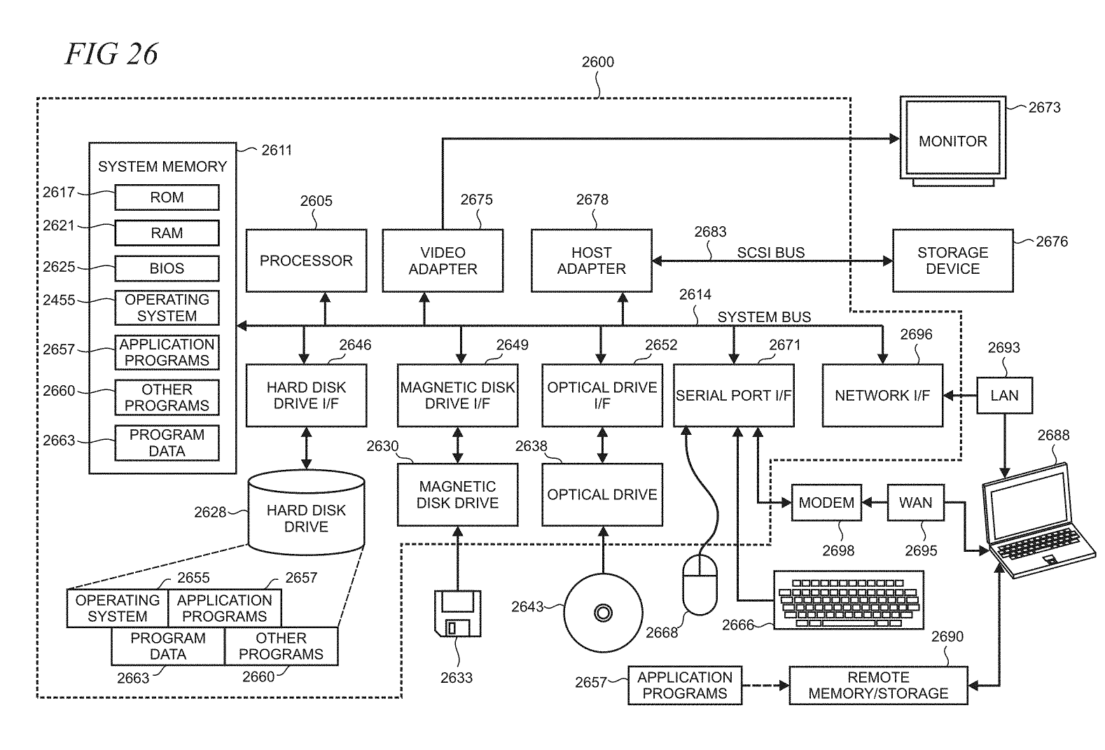

FIG. 26 is a simplified block diagram of an illustrative computer system 2600 such as a PC, client machine, or server with which the present digital assistant integration with music services may be implemented. Computer system 2600 includes a processor 2605, a system memory 2611, and a system bus 2614 that couples various system components including the system memory 2611 to the processor 2605. The system bus 2614 may be any of several types of bus structures including a memory bus or memory controller, a peripheral bus, or a local bus using any of a variety of bus architectures. The system memory 2611 includes read only memory (ROM) 2617 and random access memory (RAM) 2621. A basic input/output system (BIOS) 2625, containing the basic routines that help to transfer information between elements within the computer system 2600, such as during startup, is stored in ROM 2617. The computer system 2600 may further include a hard disk drive 2628 for reading from and writing to an internally disposed hard disk (not shown), a magnetic disk drive 2630 for reading from or writing to a removable magnetic disk 2633 (e.g., a floppy disk), and an optical disk drive 2638 for reading from or writing to a removable optical disk 2643 such as a CD (compact disc), DVD (digital versatile disc), or other optical media. The hard disk drive 2628, magnetic disk drive 2630, and optical disk drive 2638 are connected to the system bus 2614 by a hard disk drive interface 2646, a magnetic disk drive interface 2649, and an optical drive interface 2652, respectively. The drives and their associated computer-readable storage media provide non-volatile storage of computer-readable instructions, data structures, program modules, and other data for the computer system 2600. Although this illustrative example includes a hard disk, a removable magnetic disk 2633, and a removable optical disk 2643, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present digital assistant integration with music services. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2633, optical disk 2643, ROM 2617, or RAM 2621, including an operating system 2655, one or more application programs 2657, other program modules 2660, and program data 2663. A user may enter commands and information into the computer system 2600 through input devices such as a keyboard 2666 and pointing device 2668 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 2605 through a serial port interface 2671 that is coupled to the system bus 2614, but may be connected by other interfaces, such as a parallel port, game port, or universal serial bus (USB). A monitor 2673 or other type of display device is also connected to the system bus 2614 via an interface, such as a video adapter 2675. In addition to the monitor 2673, personal computers typically include other peripheral output devices (not shown), such as speakers and printers. The illustrative example shown in FIG. 26 also includes a host adapter 2678, a Small Computer System Interface (SCSI) bus 2683, and an external storage device 2676 connected to the SCSI bus 2683.

The computer system 2600 is operable in a networked environment using logical connections to one or more remote computers, such as a remote computer 2688. The remote computer 2688 may be selected as another personal computer, a server, a router, a network PC, a peer device, or other common network node, and typically includes many or all of the elements described above relative to the computer system 2600, although only a single representative remote memory/storage device 2690 is shown in FIG. 26. The logical connections depicted in FIG. 26 include a local area network (LAN) 2693 and a wide area network (WAN) 2695. Such networking environments are often deployed, for example, in offices, enterprise-wide computer networks, intranets, and the Internet.

When used in a LAN networking environment, the computer system 2600 is connected to the local area network 2693 through a network interface or adapter 2696. When used in a WAN networking environment, the computer system 2600 typically includes a broadband modem 2698, network gateway, or other means for establishing communications over the wide area network 2695, such as the Internet. The broadband modem 2698, which may be internal or external, is connected to the system bus 2614 via a serial port interface 2671. In a networked environment, program modules related to the computer system 2600, or portions thereof, may be stored in the remote memory storage device 2690. It is noted that the network connections shown in FIG. 26 are illustrative and other means of establishing a communications link between the computers may be used depending on the specific requirements of an application of the present digital assistant integration with music services.

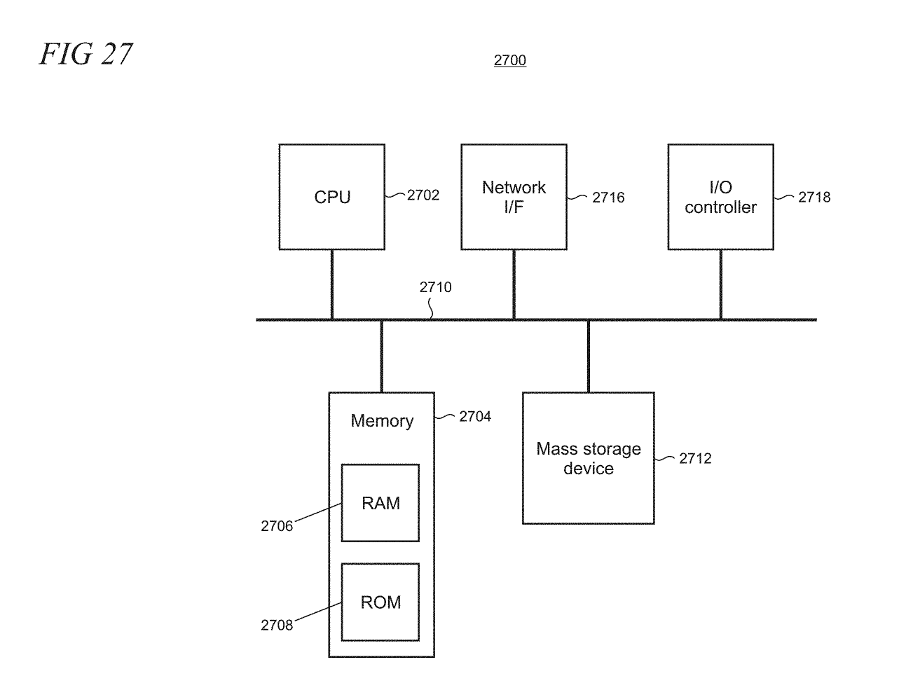

FIG. 27 shows an illustrative architecture 2700 for a device capable of executing the various components described herein for providing the present digital assistant integration with music services. Thus, the architecture 2700 illustrated in FIG. 27 shows an architecture that may be adapted for a server computer, mobile phone, a PDA, a smartphone, a desktop computer, a netbook computer, a tablet computer, GPS device, gaming console, and/or a laptop computer. The architecture 2700 may be utilized to execute any aspect of the components presented herein.

The architecture 2700 illustrated in FIG. 27 includes a CPU (Central Processing Unit) 2702, a system memory 2704, including a RAM 2706 and a ROM 2708, and a system bus 2710 that couples the memory 2704 to the CPU 2702. A basic input/output system containing the basic routines that help to transfer information between elements within the architecture 2700, such as during startup, is stored in the ROM 2708. The architecture 2700 further includes a mass storage device 2712 for storing software code or other computer-executed code that is utilized to implement applications, the file system, and the operating system.

The mass storage device 2712 is connected to the CPU 2702 through a mass storage controller (not shown) connected to the bus 2710. The mass storage device 2712 and its associated computer-readable storage media provide non-volatile storage for the architecture 2700.

Although the description of computer-readable storage media contained herein refers to a mass storage device, such as a hard disk or CD-ROM drive, it may be appreciated by those skilled in the art that computer-readable storage media can be any available storage media that can be accessed by the architecture 2700.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 2700.

According to various embodiments, the architecture 2700 may operate in a networked environment using logical connections to remote computers through a network. The architecture 2700 may connect to the network through a network interface unit 2716 connected to the bus 2710. It may be appreciated that the network interface unit 2716 also may be utilized to connect to other types of networks and remote computer systems. The architecture 2700 also may include an input/output controller 2718 for receiving and processing input from a number of other devices, including a keyboard, mouse, or electronic stylus (not shown in FIG. 27). Similarly, the input/output controller 2718 may provide output to a display screen, a printer, or other type of output device (also not shown in FIG. 27).

It may be appreciated that the software components described herein may, when loaded into the CPU 2702 and executed, transform the CPU 2702 and the overall architecture 2700 from a general-purpose computing system into a special-purpose computing system customized to facilitate the functionality presented herein. The CPU 2702 may be constructed from any number of transistors or other discrete circuit elements, which may individually or collectively assume any number of states. More specifically, the CPU 2702 may operate as a finite-state machine, in response to executable instructions contained within the software modules disclosed herein. These computer-executable instructions may transform the CPU 2702 by specifying how the CPU 2702 transitions between states, thereby transforming the transistors or other discrete hardware elements constituting the CPU 2702.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 2700 in order to store and execute the software components presented herein. It also may be appreciated that the architecture 2700 may include other types of computing devices, including handheld computers, embedded computer systems, smartphones, PDAs, and other types of computing devices known to those skilled in the art. It is also contemplated that the architecture 2700 may not include all of the components shown in FIG. 27, may include other components that are not explicitly shown in FIG. 27, or may utilize an architecture completely different from that shown in FIG. 27.

FIG. 28 shows one particular illustrative example of a see-through, augmented reality or virtual reality display system 2800, and FIG. 29 shows a functional block diagram of the system 2800. Display system 2800 comprises one or more lenses 2802 that form a part of a see-through display subsystem 2804, such that images may be displayed using lenses 2802 (e.g. using projection onto lenses 2802, one or more waveguide systems incorporated into the lenses 2802, and/or in any other suitable manner). Display system 2800 further comprises one or more outward-facing image sensors 2806 configured to acquire images of a background scene and/or physical environment being viewed by a user, and may include one or more microphones 2808 configured to detect sounds, such as voice commands from a user. Outward-facing image sensors 2806 may include one or more depth sensors and/or one or more two-dimensional image sensors. In alternative arrangements, as noted above, an augmented reality or virtual reality display system, instead of incorporating a see-through display subsystem, may display augmented reality or virtual reality images through a viewfinder mode for an outward-facing image sensor.

The display system 2800 may further include a gaze detection subsystem 2810 configured for detecting a direction of gaze of each eye of a user or a direction or location of focus, as described above. Gaze detection subsystem 2810 may be configured to determine gaze directions of each of a user's eyes in any suitable manner. For example, in the illustrative example shown, a gaze detection subsystem 2810 includes one or more glint sources 2812, such as infrared light sources, that are configured to cause a glint of light to reflect from each eyeball of a user, and one or more image sensors 2814, such as inward-facing sensors, that are configured to capture an image of each eyeball of the user. Changes in the glints from the user's eyeballs and/or a location of a user's pupil, as determined from image data gathered using the image sensor(s) 2814, may be used to determine a direction of gaze.

In addition, a location at which gaze lines projected from the user's eyes intersect the external display may be used to determine an object at which the user is gazing (e.g. a displayed virtual object and/or real background object). Gaze detection subsystem 2810 may have any suitable number and arrangement of light sources and image sensors. In some implementations, the gaze detection subsystem 2810 may be omitted.

The display system 2800 may also include additional sensors. For example, display system 2800 may comprise a global positioning system (GPS) subsystem 2816 to allow a location of the display system 2800 to be determined. This may help to identify real-world objects, such as buildings, etc. that may be located in the user's adjoining physical environment.

The display system 2800 may further include one or more motion sensors 2818 (e.g., inertial, multi-axis gyroscopic, or acceleration sensors) to detect movement and position/orientation/pose of a user's head when the user is wearing the system as part of an augmented reality or virtual reality HMD device. Motion data may be used, potentially along with eye-tracking glint data and outward-facing image data, for gaze detection, as well as for image stabilization to help correct for blur in images from the outward-facing image sensor(s) 2806. The use of motion data may allow changes in gaze location to be tracked even if image data from outward-facing image sensor(s) 2806 cannot be resolved.

In addition, motion sensors 2818, as well as microphone(s) 2808 and gaze detection subsystem 2810, also may be employed as user input devices, such that a user may interact with the display system 2800 via gestures of the eye, neck and/or head, as well as via verbal commands in some cases. It may be understood that sensors illustrated in FIGS. 28 and 29 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The display system 2800 can further include a controller 2820 having a logic subsystem 2822 and a data storage subsystem 2824 in communication with the sensors, gaze detection subsystem 2810, display subsystem 2804, and/or other components through a communications subsystem 2826. The communications subsystem 2826 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 2824 may include instructions stored thereon that are executable by logic subsystem 2822, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The display system 2800 is configured with one or more audio transducers 2828 (e.g., speakers, earphones, etc.) so that audio can be utilized as part of an augmented reality or virtual reality experience. A power management subsystem 2830 may include one or more batteries 2832 and/or protection circuit modules (PCMs) and an associated charger interface 2834 and/or remote power interface for supplying power to components in the display system 2800.

It may be appreciated that the display system 2800 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of a display device and its various sensors and subcomponents may take a variety of different forms without departing from the scope of the present arrangement.

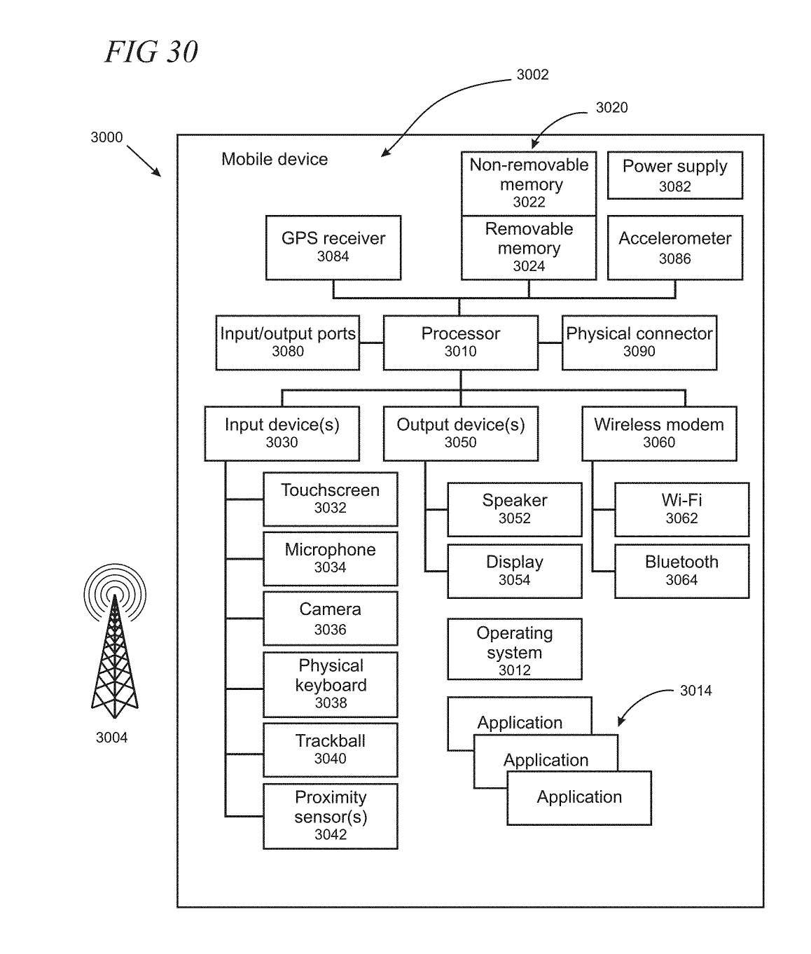

FIG. 30 is a functional block diagram of an illustrative device 3000 such as a mobile phone or smartphone including a variety of optional hardware and software components, shown generally at 3002. Any component 3002 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 3004, such as a cellular or satellite network.

The illustrated device 3000 can include a controller or processor 3010 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 3012 can control the allocation and usage of the components 3002, including power states, above-lock states, and below-lock states, and provides support for one or more application programs 3014. The application programs can include common mobile computing applications (e.g., image-capture applications, email applications, calendars, contact managers, web browsers, messaging applications), or any other computing application.

The illustrated device 3000 can include memory 3020. Memory 3020 can include non-removable memory 3022 and/or removable memory 3024. The non-removable memory 3022 can include RAM, ROM, Flash memory, a hard disk, or other well-known memory storage technologies. The removable memory 3024 can include Flash memory or a Subscriber Identity Module (SIM) card, which is well known in GSM (Global System for Mobile communications) systems, or other well-known memory storage technologies, such as “smart cards.” The memory 3020 can be used for storing data and/or code for running the operating system 3012 and the application programs 3014. Example data can include web pages, text, images, sound files, video data, or other data sets to be sent to and/or received from one or more network servers or other devices via one or more wired or wireless networks.

The memory 3020 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 3000.

The memory 3020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 3000 can support one or more input devices 3030; such as a touchscreen 3032; microphone 3034 for implementation of voice input for voice recognition, voice commands and the like; camera 3036; physical keyboard 3038; trackball 3040; and/or proximity sensor 3042; and one or more output devices 3050, such as a speaker 3052 and one or more displays 3054. Other input devices (not shown) using gesture recognition may also be utilized in some cases. Other possible output devices (not shown) can include piezoelectric or haptic output devices. Some devices can serve more than one input/output function. For example, touchscreen 3032 and display 3054 can be combined into a single input/output device.

A wireless modem 3060 can be coupled to an antenna (not shown) and can support two-way communications between the processor 3010 and external devices, as is well understood in the art. The modem 3060 is shown generically and can include a cellular modem for communicating with the mobile communication network 3004 and/or other radio-based modems (e.g., Bluetooth 3064 or Wi-Fi 3062). The wireless modem 3060 is typically configured for communication with one or more cellular networks, such as a GSM network for data and voice communications within a single cellular network, between cellular networks, or between the device and a public switched telephone network (PSTN).

The device can further include at least one input/output port 3080, a power supply 3082, a satellite navigation system receiver 3084, such as a GPS receiver, an accelerometer 3086, a gyroscope (not shown), and/or a physical connector 3090, which can be a USB port, IEEE 1394 (FireWire) port, and/or an RS-232 port. The illustrated components 3002 are not required or all-inclusive, as any components can be deleted and other components can be added.

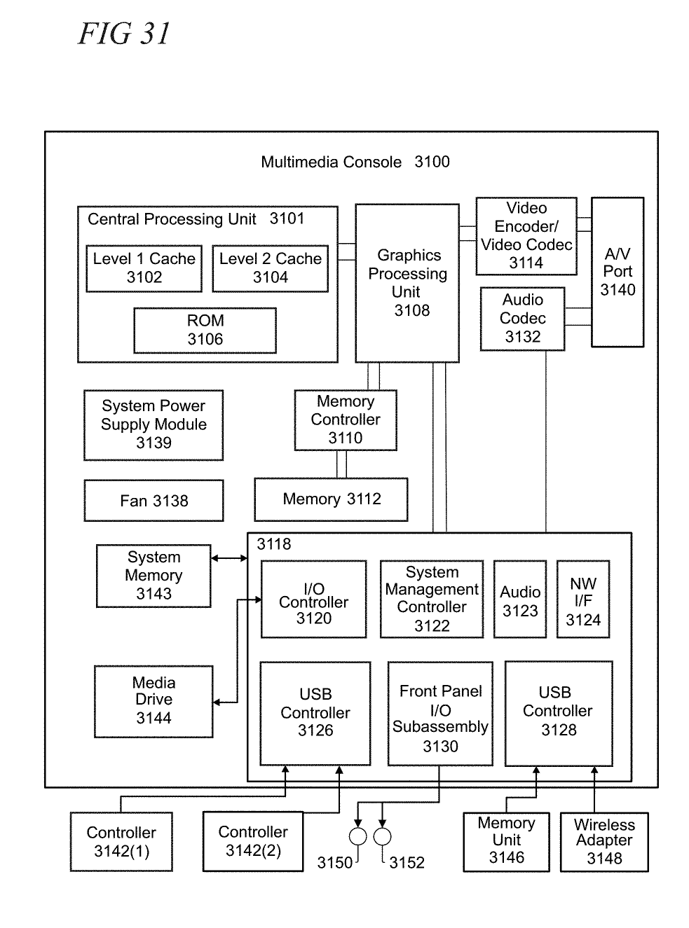

FIG. 31 is an illustrative functional block diagram of a multimedia console 3100. The multimedia console 3100 has a central processing unit (CPU) 3101 having a level 1 cache 3102, a level 2 cache 3104, and a Flash ROM (Read Only Memory) 3106. The level 1 cache 3102 and the level 2 cache 3104 temporarily store data and hence reduce the number of memory access cycles, thereby improving processing speed and throughput. The CPU 3101 may be configured with more than one core, and thus, additional level 1 and level 2 caches 3102 and 3104. The Flash ROM 3106 may store executable code that is loaded during an initial phase of a boot process when the multimedia console 3100 is powered ON.

A graphics processing unit (GPU) 3108 and a video encoder/video codec (coder/decoder) 3114 form a video processing pipeline for high speed and high resolution graphics processing. Data is carried from the GPU 3108 to the video encoder/video codec 3114 via a bus. The video processing pipeline outputs data to an A/V (audio/video) port 3140 for transmission to a television or other display. A memory controller 3110 is connected to the GPU 3108 to facilitate processor access to various types of memory 3112, such as, but not limited to, a RAM.

The multimedia console 3100 includes an I/O controller 3120, a system management controller 3122, an audio processing unit 3123, a network interface controller 3124, a first USB (Universal Serial Bus) host controller 3126, a second USB controller 3128, and a front panel I/O subassembly 3130 that are preferably implemented on a module 3118. The USB controllers 3126 and 3128 serve as hosts for peripheral controllers 3142(1) and 3142(2), a wireless adapter 3148, and an external memory device 3146 (e.g., Flash memory, external CD/DVD ROM drive, removable media, etc.). The network interface controller 3124 and/or wireless adapter 3148 provide access to a network (e.g., the Internet, home network, etc.) and may be any of a wide variety of various wired or wireless adapter components including an Ethernet card, a modem, a Bluetooth module, a cable modem, or the like.

System memory 3143 is provided to store application data that is loaded during the boot process. A media drive 3144 is provided and may comprise a DVD/CD drive, hard drive, or other removable media drive, etc. The media drive 3144 may be internal or external to the multimedia console 3100. Application data may be accessed via the media drive 3144 for execution, playback, etc. by the multimedia console 3100. The media drive 3144 is connected to the I/O controller 3120 via a bus, such as a Serial ATA bus or other high speed connection (e.g., IEEE 1394).

The system management controller 3122 provides a variety of service functions related to assuring availability of the multimedia console 3100. The audio processing unit 3123 and an audio codec 3132 form a corresponding audio processing pipeline with high fidelity and stereo processing. Audio data is carried between the audio processing unit 3123 and the audio codec 3132 via a communication link. The audio processing pipeline outputs data to the A/V port 3140 for reproduction by an external audio player or device having audio capabilities.

The front panel I/O subassembly 3130 supports the functionality of the power button 3150 and the eject button 3152, as well as any LEDs (light emitting diodes) or other indicators exposed on the outer surface of the multimedia console 3100. A system power supply module 3139 provides power to the components of the multimedia console 3100. A fan 3138 cools the circuitry within the multimedia console 3100.

The CPU 3101, GPU 3108, memory controller 3110, and various other components within the multimedia console 3100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 3100 is powered ON, application data may be loaded from the system memory 3143 into memory 3112 and/or caches 3102 and 3104 and executed on the CPU 3101. The application may present a graphical user interface that provides a consistent user experience when navigating to different media types available on the multimedia console 3100. In operation, applications and/or other media contained within the media drive 3144 may be launched or played from the media drive 3144 to provide additional functionalities to the multimedia console 3100.

The multimedia console 3100 may be operated as a standalone system by simply connecting the system to a television or other display. In this standalone mode, the multimedia console 3100 allows one or more users to interact with the system, watch movies, or listen to music. However, with the integration of broadband connectivity made available through the network interface controller 3124 or the wireless adapter 3148, the multimedia console 3100 may further be operated as a participant in a larger network community.

When the multimedia console 3100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 3100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 3101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 3142(1) and 3142(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Various exemplary embodiments of the present digital assistant integration with music services are now presented by way of illustration and not as an exhaustive list of all embodiments. An example includes a device, comprising: one or more processors; a user interface (UI) configured to provide interactions with a user of the device; and a hardware-based memory device storing computer-readable instructions which, when executed by the one or more processors, cause the device to expose a digital assistant on the device, the digital assistant configured to maintain context awareness by monitoring the user interactions with the device, or by accessing contextual data associated with the user or the device, configure the digital assistant for interactions with one or more remote services including at least a music service or a search service, operate the digital assistant to generate a playlist of content that is personalized to the user utilizing the context awareness, render the playlist of content on the device, and provide curation for the content as the playlist is rendered.

In another example, the executed instructions further cause the device to receive an interaction from the user using one of voice, physical interaction, or gesture. In another example, the curation comprises the digital assistant providing commentary through the UI using one of audio, graphic content, or video, the commentary pertaining to content in the playlist. In another example, the digital assistant utilizes processing that is provided, at least in part, by one or more remote servers. In another example, the executed instructions further cause the device to maintain context awareness using data comprising one or more of time/date, location of the user or device, language, schedule, applications installed on the device, user preferences, user behaviors, user activities, stored contacts, call history, messaging history, browsing history, application usage history, device type, device capabilities, or communication network type. In another example, the executed instructions further cause the digital assistant to predict an intention of the user based on the context awareness and use the prediction to offer a curated listening experience to the user. In another example, the context awareness is further maintained by using sensor data collected by sensors on the device, the sensors including one or more of camera, accelerometer, location-awareness component, thermometer, altimeter, heart rate sensor, barometer, microphone, or proximity sensor. In another example, the executed instructions further cause the device to perform an action on behalf of the user. In another example, the action comprises one or more of sharing contact information, reading an email to identify tasks contained therein, adding a task to a task list, scheduling a meeting or appointment, interacting with a user's calendar, making a telephone call, sending a message, operating a device, making a reservation, providing a reminder to the user, making a purchase, suggesting a workout, playing music, taking notes, providing information to the user or another party, answering a question from the user or another party, setting an alarm or reminder, checking social media for updates, visiting a website, interacting with a search service, sharing or showing files, sending a link to a website, or sending a link to a resource.

A further example includes a method for providing a curated listening experience to a user of one or more devices, comprising: configuring a digital assistant to a) interact with the user across each of the one or more devices using at least one of voice, physical interaction, or sensed gesture and b) collect contextual data associated with the user or one or more of the devices; monitoring the user's interactions with the devices to create a usage history; and using the contextual data and usage history to identify a context with which to suggest a curated listening experience to the user, and surfacing a notification suggesting that the user participate in the curated listening experience upon an occurrence of the identified context, wherein the curated listening experience comprises a playlist of content and wherein the digital assistant provides commentary pertaining to the content as the playlist is played on the one or more devices.

In another example, the identified context is based on one or more of location, time, mood of the user, user schedule, biometric characteristic of the user, usage history, or play history. In another example, the method further comprises configuring the digital assistant to use contextual data and usage history to curate the listening experience to the user. In another example, the method further comprises configuring the digital assistant to provide information, content, or recommendations pertaining to the content as the playlist is played on the one or more devices. In another example, the method further comprises configuring the digital assistant to interact with a music service or music application to generate the playlist. In another example, the method further comprises configuring the digital assistant to interact with a search service or search application to generate the commentary. In another example, the notification uses one of audio, graphics, or haptic interactions with the user.

A further example includes one or more computer-readable memory devices storing instructions which, when executed by one or more processors disposed in a computer server, cause the computer server to: receive monitoring data from a device associated with a user in which the monitoring data describes interactions between the user and the device; receive contextual data associated with either the user or the device; generate a playlist of content personalized to the user based on the monitoring data and the contextual data; generate curation for the content in the playlist, the curation including at least one of commentary, information, or recommendations; and communicate with a digital assistant instantiated on the device so that the digital assistant is enabled to i) interact with the user to receive feedback on the personalized playlist, and ii) provide the curation for the playlist as it plays on the device.

In another example, the executed instructions cause the computer server to communicate with the digital assistant to enable the digital assistant to surface on a device user interface (UI) one or more links to content or user experiences that are related to the playlist. In another example, the executed instructions cause the computer server to use the feedback when generating future playlists or future curation. In another example, the device is a head-mounted display (HMD) device and the curation is provided by the digital assistant as virtual reality or mixed reality images are rendered on the HMD device.

Based on the foregoing, it may be appreciated that technologies for digital assistant integration with music services have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and is not be construed as limiting. Various modifications and changes may be made to the subject matter described herein without following the example embodiments and applications illustrated and described, and without departing from the true spirit and scope of the present invention, which is set forth in the following claims.

What is claimed:

1. A device, comprising:
one or more processors;
a user interface (UI) configured to provide interactions with a user of the device; and
a hardware-based memory device storing computer-readable instructions which, when executed by the one or more processors, cause the device to
expose a digital assistant on the device, the digital assistant configured to maintain context awareness by monitoring the user interactions with the device, or by accessing contextual data associated with the user or the device,
configure the digital assistant for interactions with one or more remote services including at least a music service or a search service,
operate the digital assistant to generate a playlist of content that is personalized to the user utilizing the context awareness,
render the playlist of content on the device, and
provide curation for the content as the playlist is rendered.

2. The device of claim 1 in which the executed instructions further cause the device to receive an interaction from the user using one of voice, physical interaction, or gesture.

3. The device of claim 1 in which the curation comprises the digital assistant providing commentary through the UI using one of audio, graphic content, or video, the commentary pertaining to content in the playlist.

4. The device of claim 1 in which the digital assistant utilizes processing that is provided, at least in part, by one or more remote servers.

5. The device of claim 1 in which the executed instructions further cause the device to maintain context awareness using data comprising one or more of time/date, location of the user or device, language, schedule, applications installed on the device, user preferences, user behaviors, user activities, stored contacts, call history, messaging history, browsing history, application usage history, device type, device capabilities, or communication network type.

6. The device of claim 1 in which the executed instructions further cause the digital assistant to predict an intention of the user based on the context awareness and use the prediction to offer a curated listening experience to the user.

7. The device of claim 1 in which the context awareness is further maintained by using sensor data collected by sensors on the device, the sensors including one or more of camera, accelerometer, location-awareness component, thermometer, altimeter, heart rate sensor, barometer, microphone, or proximity sensor.

8. The device of claim 1 in which the executed instructions further cause the device to perform an action on behalf of the user.

9. The device of claim 8 in which the action comprises one or more of sharing contact information, reading an email to identify tasks contained therein, adding a task to a task list, scheduling a meeting or appointment, interacting with a user's calendar, making a telephone call, sending a message, operating a device, making a reservation, providing a reminder to the user, making a purchase, suggesting a workout, playing music, taking notes, providing information to the user or another party, answering a question from the user or another party, setting an alarm or reminder, checking social media for updates, visiting a website, interacting with a search service, sharing or showing files, sending a link to a website, or sending a link to a resource.

10. A method for providing a curated listening experience to a user of one or more devices, comprising:
configuring a digital assistant to a) interact with the user across each of the one or more devices using at least one of voice, physical interaction, or sensed gesture and b) collect contextual data associated with the user or one or more of the devices;
monitoring the user's interactions with the devices to create a usage history; and
using the contextual data and usage history to identify a context with which to suggest a curated listening experience to the user, and
surfacing a notification suggesting that the user participate in the curated listening experience upon an occurrence of the identified context,
wherein the curated listening experience comprises a playlist of content and wherein the digital assistant provides commentary pertaining to the content as the playlist is played on the one or more devices.

11. The method of claim 10 in which the identified context is based on one or more of location, time, mood of the user, user schedule, biometric characteristic of the user, usage history, or play history.

12. The method of claim 10 further comprising configuring the digital assistant to use contextual data and usage history to curate the listening experience to the user.

13. The method of claim 10 further comprising configuring the digital assistant to provide information, content, or recommendations pertaining to the content as the playlist is played on the one or more devices.

14. The method of claim 10 further comprising configuring the digital assistant to interact with a music service or music application to generate the playlist.

15. The method of claim 10 further comprising configuring the digital assistant to interact with a search service or search application to generate the commentary.

16. The method of claim 10 in which the notification uses one of audio, graphics, or haptic interactions with the user.

17. One or more computer-readable memory devices storing instructions which, when executed by one or more processors disposed in a computer server, cause the computer server to:
receive monitoring data from a device associated with a user in which the monitoring data describes interactions between the user and the device;
receive contextual data associated with either the user or the device;
generate a playlist of content personalized to the user based on the monitoring data and the contextual data;
generate curation for the content in the playlist, the curation including at least one of commentary, information, or recommendations; and
communicate with a digital assistant instantiated on the device so that the digital assistant is enabled to i) interact with the user to receive feedback on the personalized playlist, and ii) provide the curation for the playlist as it plays on the device.

18. The one or more computer-readable memory devices of claim 17 in which the executed instructions cause the computer server to communicate with the digital assistant to enable the digital assistant to surface on a device user interface (UI) one or more links to content or user experiences that are related to the playlist.

19. The one or more computer-readable memory devices of claim 17 in which the executed instructions cause the computer server to use the feedback when generating future playlists or future curation.

20. The one or more computer-readable memory devices of claim 17 in which the device is a head-mounted display (HMD) device and the curation is provided by the digital assistant as virtual reality or mixed reality images are rendered on the HMD device.
